(19) United States
(12) Patent Application Publication
(10) Pub. No.: US 2014/0327320 A1
(43) Pub. Date: Nov. 6, 2014

(54) WIRELESS ENERGY TRANSFER

(71) Applicant: WiTricity Corporation, Watertown, MA (US)

(72) Inventors: Jeffrey Muhs, River Heights, UT (US); Aaron Gilchrist, Logan, UT (US); Kylee D. Sealy, Logan, UT (US); Andre B. Kurs, Chestnut Hill, MA (US); Alexander P. McCauley, Cambridge, MA (US); Morris P. Kesler, Bedford, MA (US); Katherine L. Hall, Arlington, MA (US); Gozde Guckaya, Belmont, MA (US)

(21) Appl. No.: 14/267,775

(22) Filed: May 1, 2014

Related U.S. Application Data
(60) Provisional application No. 61/818,149, filed on May 1, 2013.
(60) Provisional application No. 61/823,974, filed on May 16, 2013.
(60) Provisional application No. 61/825,937, filed on May 21, 2013.
(60) Provisional application No. 61/825,942, filed on May 21, 2013.
(60) Provisional application No. 61/826,230, filed on May 22, 2013.
(60) Provisional application No. 61/839,262, filed on Jun. 25, 2013.
(60) Provisional application No. 61/861,097, filed on Aug. 1, 2013.

(51) Int. Cl. H04B 5/00; H01F 38/14

(52) U.S. Cl. CPC H04B 5/0037; H01F 38/14
USPC 307/104

(57) ABSTRACT

A wireless energy transfer system includes wirelessly powered footwear. Device resonators in footwear may capture energy from source resonators. Captured energy may be used to generate thermal energy in the footwear. Wireless energy may be generated by wireless warming installations. Installations may be located in public locations and may activate when a user is near the installation. In some cases, the warming installations may include interactive displays and may require user input to activate energy transfer.

### CROSS REFERENCE TO RELATED APPLICATIONS

This application claims the benefit of the following applications each of which is hereby incorporated by reference in its entirety: U.S. Provisional Application No. 61/818,149 filed on May 1, 2013; U.S. Provisional Application 61/823,974, filed on May 16, 2013; U.S. Provisional Application No. 61/825,937 filed on May 21, 2013; U.S. Provisional Application No. 61/825,942 filed on May 21, 2013; U.S. Provisional Application No. 61/826,230 filed on May 22, 2013; U.S. Provisional Application No. 61/839,262 filed on Jun. 25, 2013; and U.S. Provisional Application No. 61/861,097 filed on Aug. 1, 2013. The entire contents of each of the foregoing applications are incorporated by reference herein.

### BACKGROUND OF THE INVENTION

Energy or power may be transferred wirelessly using a variety of known radiative, or far-field, and non-radiative, or near-field, techniques as detailed, for example, in commonly owned U.S. patent application Ser. No. 12/613,686 published on May 6, 2010 as US 2010/010909445 and entitled “Wireless Energy Transfer Systems,” U.S. patent application Ser. No. 12/860,375 published on Dec. 9, 2010 as 2010/0308939 and entitled “Integrated Resonator-Shield Structures,” U.S. patent application Ser. No. 13/222,915 published on Mar. 15, 2012 as 2012/0062345 and entitled “Low Resistance Electrical Conductor,” the contents of which are incorporated by reference.

Wireless energy transfer may be difficult to incorporate or deploy in many environments. Efficiency of energy transfer, practicality, safety, cost, are factors that prohibit the deployment for many applications. Therefore a need exists for a wireless energy transfer that addresses such practical challenges to allow widespread use of wireless energy transfer in typical user environments.

### SUMMARY

In general, in a first aspect, the disclosure features wireless power stations that include a base featuring at least one source resonator, an interactive display terminal, at least one sensor, and a controller connected to the at least one source resonator, the display terminal, and the sensor, where during operation of the system, the controller is configured to: determine a location of a user of the wireless power station based on measurement information from the sensor; activate the at least one source resonator to generate a magnetic field to wirelessly transmit electrical power to a receiver resonator positioned in footwear worn by the user; display a request for user input on the interactive display terminal; and discontinue wireless power transfer if a response to the request is not received from the user after a time interval.

Embodiments of the stations can include any one or more of the following features.

The controller can be configured to activate the at least one source resonator near the location of a user. The interactive display terminal can display interactive marketing content.

The at least one sensor can include a pressure sensor.

The base can be configured to transfer energy to footwear positioned on a top surface of the base, and the at least one source resonator can be arranged with its dipole moment perpendicular to the top surface of the base.

The warming station can be in a ski lift line.

Embodiments of the stations can also include any of the other features disclosed herein, including features disclosed in connection with different embodiments, in any combination as appropriate.

In another aspect, the disclosure features footwear insoles that include a core formed of a non-metallic material and featuring an upper surface and a lower surface, where the upper surface is positioned closer to a user's foot than the lower surface when the insole is worn, a heating element attached to the upper surface, and a resonator featuring a resonator coil attached to the lower surface and positioned so that the resonator coil is laterally offset relative to the heating element, where the resonator coil is oriented so that during operation of the insole, the resonator coil has a dipole moment perpendicular to a portion of the lower surface to which the resonator coil is attached.

Embodiments of the insoles can include any one or more of the following features.

The heating element can be a resistive heating element. The resonator coil can include an electrically conductive thread.

The insoles can include a temperature sensor and a controller, where the controller is configured to change a resonant frequency of the resonator in response to temperature readings from the temperature sensor. The resonator can be detuned from a set resonant frequency when the temperature reaches a threshold temperature.

The insoles can include a heat sensitive element that is configured to detune the resonator from a set resonant frequency as a temperature of the heating element increases. The heat sensitive element can include a capacitive element coupled to the resonator coil, and a capacitance of the heat sensitive element can increase with increased temperature. The heat sensitive element can include a capacitive element coupled to the resonator coil, and a capacitance of the heat sensitive element can decrease with increased temperature.

The insoles can include a wirelessly rechargeable battery.

Embodiments of the insoles can also include any of the other features disclosed herein, including features disclosed in connection with different embodiments, in any combination as appropriate.

In a further aspect, the disclosure features methods for wirelessly transferring power to an article of footwear that include detecting a position of the footwear article relative to a wireless power source, activating a wireless power source based on the detected position to wirelessly transfer power to the footwear article, displaying a request for action by a wearer of the footwear article, and discontinuing wireless power transfer to the footwear article if a response to the request is not received after a time interval.

Embodiments of the methods can include any one or more of the following features.

The methods can include detecting the position of the article relative to the source with proximity sensors. The methods can include detecting the position of the article relative to the source using the wireless power source.

The request for action displayed to the wearer can include interactive marketing material. The request for action displayed to the wearer can include a temperature control.

Embodiments of the methods can also include any of the other features or steps disclosed herein, including features and steps disclosed in connection with different embodiments, in any combination as appropriate.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a system block diagram of wireless energy transfer configurations.

FIGS. 2A-2F are exemplary structures and schematics of simple resonator transfer.

FIGS. 3A-B are diagrams showing two resonator configurations with repeater resonators.

FIGS. 4A-B are diagrams showing two resonator configurations with repeater resonators.

FIG. 5A is a diagram showing a configuration with two repeater resonators and 5B is a diagram showing a resonator configuration with a device resonator acting as a repeater resonator.

FIG. 6 shows a cutaway view of an embodiment of wirelessly powered footwear.

FIG. 7 shows a block diagram of an embodiment of wireless powered footwear.

FIGS. 8A-B show an embodiment of wirelessly powered insole.

FIGS. 9A-B show embodiments of a cross section of a wirelessly powered insole.

FIGS. 10A-B illustrate an embodiment of a wireless ready boot.

FIG. 11 is an embodiment of wireless warming station.

FIG. 12 is an embodiment of a method for operating a wireless warming station.

FIG. 13A shows one embodiment of a wirelessly powered card. FIG. 13B shows a cross-section of an embodiment of a wirelessly charged or powered multi-use card.

FIG. 14 shows one embodiment of a block diagram of a wirelessly transfer system.

FIGS. 15A and 15B show embodiments of the resonator coils suitable for hearing aid applications.

FIG. 16A shows coil-to-coil efficiency between a wireless power source and a hearing aid device as the size of the source coil is varied from 20 to 40 mm. FIG. 16B shows the calculated coupling coefficient of the system as the size of the source coil is varied from 20 to 40 mm.

FIG. 17 shows a graph with calculated efficiency for a resonator separation of 15 cm.

FIG. 18 shows an embodiment utilizing conductive ink resonator coils.

FIGS. 19A and 19B show embodiments of items utilizing conductive ink resonator coils.

FIGS. 20A and 20B shows embodiments of a wireless cup warmer.

### DETAILED DESCRIPTION

Wireless energy transfer can be configured for footwear applications. Energy may be wirelessly transferred to device resonators that may be attached to footwear, inside footwear, or associated with footwear. Transferred energy may be used to provide heating or cooling to the footwear, provide power or energy for sensors, electronics, or systems of the footwear.

Wireless energy stations may be used to transfer energy to footwear. Wireless energy stations may be configured as “warming stations” providing energy for heating in cold climates. Warming stations may be deployed in public transit locations, outdoors, ski areas, residences, and in other applications.

Wireless energy transfer may be used in hearing aids, underwater submersibles, clothing, and other applications.

Wireless energy transfer systems described herein may be implemented using a wide variety of resonators and resonant objects. As those skilled in the art will recognize, important considerations for resonator-based power transfer include resonator efficiency and resonator coupling. Extensive discussion of such issues, e.g., coupled mode theory (CMT), coupling coefficients and factors, quality factors (also referred to as Q-factors), and impedance matching is provided, for example, in U.S. patent application Ser. No. 12/789,611 published on Sep. 23, 2010 as US 20100237709 and entitled “RESONATOR ARRAYS FOR WIRELESS ENERGY TRANSFER,” and U.S. patent application Ser. No. 12/722,050 published on Jul. 22, 2010 as US 20100181843 and entitled “WIRELESS ENERGY TRANSFER FOR REFRIGERATOR APPLICATION” and incorporated herein by reference in its entirety as if fully set forth herein.

A resonator may be defined as a resonant structure that can store energy in at least two different forms, and where the stored energy oscillates between the two forms. The resonant structure will have a specific oscillation mode with a resonant (modal) frequency, f, and a resonant (modal) field. The angular resonant frequency, a, may be defined as ω=2πf, the resonant period, T, may be defined as T=1/f=2π/ω, and the resonant wavelength, λ, may be defined as λ=c/f, where c is the speed of the associated field waves (light, for electromagnetic resonators). In the absence of loss mechanisms, coupling mechanisms or external energy supplying or draining mechanisms, the total amount of energy stored by the resonator, W, would stay fixed, but the form of the energy would oscillate between the two forms supported by the resonator, wherein one form would be maximum when the other is minimum and vice versa.

For example, a resonator may be constructed such that the two forms of stored energy are magnetic energy and electric energy. Further, the resonator may be constructed such that the electric energy stored by the electric field is primarily confined within the structure while the magnetic energy stored by the magnetic field is primarily in the region surrounding the resonator. In other words, the total electric and magnetic energies would be equal, but their localization would be different. Using such structures, energy exchange between at least two structures may be mediated by the resonant magnetic near-field of the at least two resonators. These types of resonators may be referred to as magnetic resonators.

An important parameter of resonators used in wireless power transmission systems is the Quality Factor, or Q-factor, or Q, of the resonator, which characterizes the energy decay and is inversely proportional to energy losses of the resonator. It may be defined as Q=ω*W/P, where P is the time-averaged power lost at steady state. That is, a resonator with a high-Q has relatively low intrinsic losses and can store energy for a relatively long time. Since the resonator loses energy at its intrinsic decay rate, 2Γ, its Q, also referred to as its intrinsic Q, is given by Q=ω/2Γ. The quality factor also represents the number of oscillation periods, T, it takes for the energy in the resonator to decay by a factor of e^{-2π}. Note that the quality factor or intrinsic quality factor or Q of the resonator is that due only to intrinsic loss mechanisms. The Q of a resonator connected to, or coupled to a power generator, g, or load, l, may be called the “loaded quality factor” or the “loaded Q”. The Q of a resonator in the presence of an extraneous object that is not intended to be part of the energy transfer system may be called the “perturbed quality factor” or the “perturbed Q”.

Resonators, coupled through any portion of their near-fields may interact and exchange energy. The efficiency of this energy transfer can be significantly enhanced if the resonators operate at substantially the same resonant frequency. By way of example, but not limitation, imagine a source resonator with Qₛ, and a device resonator with Q_{d}. High-Q wireless energy transfer systems may utilize resonators that are high-Q. The Q of each resonator may be high. The geometric mean of the resonator Q's, \sqrt{QₛQ_{d}} may also or instead be high.

The coupling factor, k, is a number between 0≦|k|≦1, and it may be independent (or nearly independent) of the resonant frequencies of the source and device resonators, when those are placed at sub-wavelength distances. Rather the coupling factor k may be determined mostly by the relative geometry and the distance between the source and device resonators where the physical decay-law of the field mediating their coupling is taken into account. The coupling coefficient used in CMT, K=k\sqrt{ωₛω_{d}}/2, may be a strong function of the resonant frequencies, as well as other properties of the resonator structures. In applications for wireless energy transfer utilizing the near-fields of the resonators, it is desirable to have the size of the resonator be much smaller than the resonant wavelength, so that power lost by radiation is reduced. In some embodiments, high-Q resonators are sub-wavelength structures. In some electromagnetic embodiments, high-Q resonator structures are designed to have resonant frequencies higher than 100 kHz. In other embodiments, the resonant frequencies may be less than 1 GHz.

In exemplary embodiments, the power radiated into the far-field by these sub wavelength resonators may be further reduced by lowering the resonant frequency of the resonators and the operating frequency of the system. In other embodiments, the far field radiation may be reduced by arranging for the far fields of two or more resonators to interfere destructively in the far field.

In a wireless energy transfer system a resonator may be used as a wireless energy source, a wireless energy capture device, a repeater or a combination thereof. In embodiments a resonator may alternate between transferring energy, receiving energy or relaying energy. In a wireless energy transfer system one or more magnetic resonators may be coupled to an energy source and be energized to produce an oscillating magnetic near-field. Other resonators that are within the oscillating magnetic near-fields may capture these fields and convert the energy into electrical energy that may be used to power or charge a load thereby enabling wireless transfer of useful energy.

The so-called “useful” energy in a useful energy exchange is the energy or power that must be delivered to a device in order to power or charge it at an acceptable rate. The transfer efficiency that corresponds to a useful energy exchange may be system or application-dependent. For example, high power vehicle charging applications that transfer kilowatts of power may need to be at least 80% efficient in order to supply useful amounts of power resulting in a useful energy exchange sufficient to recharge a vehicle battery without significantly heating up various components of the transfer system. In some consumer electronics applications, a useful energy exchange may include any energy transfer efficiencies greater than 10%, or any other amount acceptable to keep rechargeable batteries “topped off” and running for long periods of time. In implanted medical device applications, a useful energy exchange may be any exchange that does not harm the patient but that extends the life of a battery or wakes up a sensor or monitor or stimulator. In such applications, 100 mW of power or less may be useful. In distributed sensing applications, power transfer of microwatts may be useful, and transfer efficiencies may be well below 1%.

A useful energy exchange for wireless energy transfer in a powering or recharging application may be efficient, highly efficient, or efficient enough, as long as the wasted energy levels, heat dissipation, and associated field strengths are within tolerable limits and are balanced appropriately with related factors such as cost, weight, size, and the like.

The resonators may be referred to as source resonators, device resonators, first resonators, second resonators, repeater resonators, and the like. Implementations may include three (3) or more resonators. For example, a single source resonator may transfer energy to multiple device resonators or multiple devices. Energy may be transferred from a first device to a second, and then from the second device to the third, and so forth. Multiple sources may transfer energy to a single device or to multiple devices connected to a single device resonator or to multiple devices connected to multiple device resonators. Resonators may serve alternately or simultaneously as sources, devices, and/or they may be used to relay power from a source in one location to a device in another location. Intermediate electromagnetic resonators may be used to extend the distance range of wireless energy transfer systems and/or to generate areas of concentrated magnetic near-fields. Multiple resonators may be daisy-chained together, exchanging energy over extended distances and with a wide range of sources and devices. For example, a source resonator may transfer power to a device resonator via several repeater resonators. Energy from a source may be transferred to a first repeater resonator, the first repeater resonator may transfer the power to a second repeater resonator and the second to a third and so on until the final repeater resonator transfers its energy to a device resonator. In this respect the range or distance of wireless energy transfer may be extended and/or tailored by adding repeater resonators. High power levels may be split between multiple sources, transferred to multiple devices and recombined at a distant location.

The resonators may be designed using coupled mode theory models, circuit models, electromagnetic field models, and the like. The resonators may be designed to have tunable characteristic sizes. The resonators may be designed to handle different power levels. In exemplary embodiments, high power resonators may require larger conductors and higher current or voltage rated components than lower power resonators.

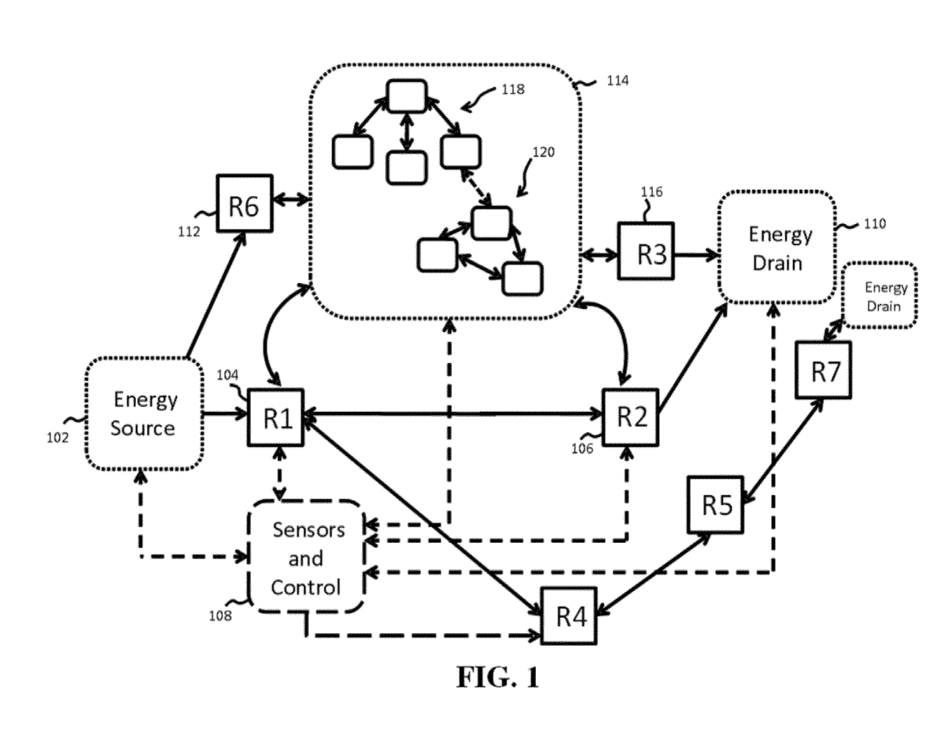

FIG. 1 shows a diagram of exemplary configurations and arrangements of a wireless energy transfer system. A wireless energy transfer system may include at least one source resonator (R1) 104 (optionally R6, 112) coupled to an energy source 102 and optionally a sensor and control unit 108. The energy source may be a source of any type of energy capable of being converted into electrical energy that may be used to drive the source resonator 104. The energy source may be a battery, a solar panel, the electrical mains, a wind or water turbine, an electromagnetic resonator, a generator, and the like. The electrical energy used to drive the magnetic resonator is converted into oscillating magnetic fields by the resonator. The oscillating magnetic fields may be captured by other resonators which may be device resonators (R2) 106, (R3) 116 that are optionally coupled to an energy drain 110. The oscillating fields may be optionally coupled to repeater resonators (R4, R5) that are configured to extend or tailor the wireless energy transfer region. Device resonators may capture the magnetic fields in the vicinity of source resonator(s), repeater resonators and other device resonators and convert them into electrical energy that may be used by an energy drain. The energy drain 110 may be an electrical, electronic, mechanical or chemical device and the like configured to receive electrical energy. Repeater resonators may capture magnetic fields in the vicinity of source, device and repeater resonator(s) and may pass the energy on to other resonators.

A wireless energy transfer system may comprise a single source resonator 104 coupled to an energy source 102 and a single device resonator 106 coupled to an energy drain 110. In embodiments a wireless energy transfer system may comprise multiple source resonators coupled to one or more energy sources and may comprise multiple device resonators coupled to one or more energy drains.

In embodiments the energy may be transferred directly between a source resonator 104 and a device resonator 106. In other embodiments the energy may be transferred from one or more source resonators 104, 112 to one or more device resonators 106, 116 via any number of intermediate resonators which may be device resonators, source resonators, repeater resonators, and the like. Energy may be transferred via a network or arrangement of resonators 114 that may include subnetworks 118, 120 arranged in any combination of topologies such as token ring, mesh, ad hoc, and the like.

In embodiments the wireless energy transfer system may comprise a centralized sensing and control system 108. In embodiments parameters of the resonators, energy sources, energy drains, network topologies, operating parameters, etc. may be monitored and adjusted from a control processor to meet specific operating parameters of the system. A central control processor may adjust parameters of individual components of the system to optimize global energy transfer efficiency, to optimize the amount of power transferred, and the like. Other embodiments may be designed to have a substantially distributed sensing and control system. Sensing and control may be incorporated into each resonator or group of resonators, energy sources, energy drains, and the like and may be configured to adjust the parameters of the individual components in the group to maximize or minimize the power delivered, to maximize energy transfer efficiency in that group and the like.

In embodiments, components of the wireless energy transfer system may have wireless or wired data communication links to other components such as devices, sources, repeaters, power sources, resonators, and the like and may transmit or receive data that can be used to enable the distributed or centralized sensing and control. A wireless communication channel may be separate from the wireless energy transfer channel, or it may be the same. In one embodiment the resonators used for power exchange may also be used to exchange information. In some cases, information may be exchanged by modulating a component in a source or device circuit and sensing that change with port parameter or other monitoring equipment. Resonators may signal each other by tuning, changing, varying, dithering, and the like, the resonator parameters such as the impedance of the resonators which may affect the reflected impedance of other resonators in the system. The systems and methods described herein may enable the simultaneous transmission of power and communication signals between resonators in wireless power transmission systems, or it may enable the transmission of power and communication signals during different time periods or at different frequencies using the same magnetic fields that are used during the wireless energy transfer. In other embodiments wireless communication may be enabled with a separate wireless communication channel such as WiFi, Bluetooth, Infrared, NFC, and the like.

In embodiments, a wireless energy transfer system may include multiple resonators and overall system performance may be improved by control of various elements in the system. For example, devices with lower power requirements may tune their resonant frequency away from the resonant frequency of a high-power source that supplies power to devices with higher power requirements. For another example, devices needing less power may adjust their rectifier circuits so that they draw less power from the source. In these ways, low and high power devices may safely operate or charge from a single high power source. In addition, multiple devices in a charging zone may find the power available to them regulated according to any of a variety of consumption control algorithms such as First-Come-First-Serve, Best Effort, Guaranteed Power, etc. The power consumption algorithms may be hierarchical in nature, giving priority to certain users or types of devices, or it may support any number of users by equally sharing the power that is available in the source. Power may be shared by any of the multiplexing techniques described in this disclosure.

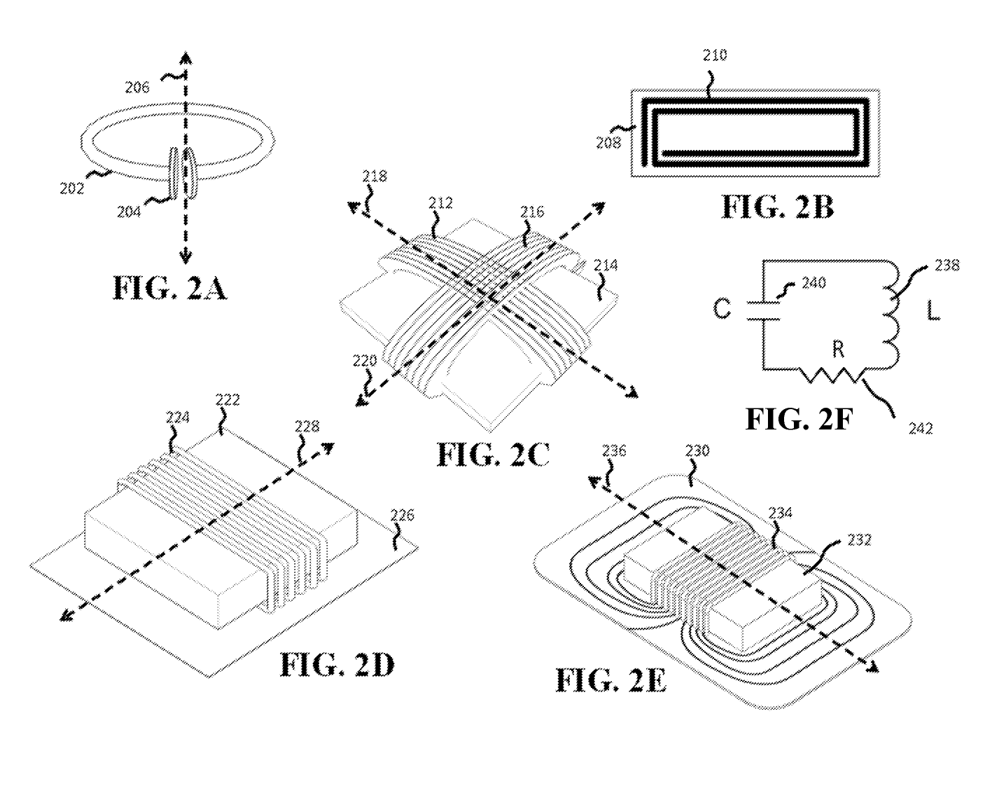

In embodiments electromagnetic resonators may be realized or implemented using a combination of shapes, structures, and configurations. Electromagnetic resonators may include an inductive element, a distributed inductance, or a combination of inductances with a total inductance, I, and a capacitive element, a distributed capacitance, or a combination of capacitances, with a total capacitance, C. A minimal circuit model of an electromagnetic resonator comprising capacitance, inductance and resistance, is shown in FIG. 2F. The resonator may include an inductive element 238 and a capacitive element 240. Provided with initial energy, such as electric field energy stored in the capacitor 240, the system will oscillate as the capacitor discharges transferring energy into magnetic field energy stored in the inductor 238 which in turn transfers energy back into electric field energy stored in the capacitor 240. Intrinsic losses in these electromagnetic resonators include losses due to resistance in the inductive and capacitive elements and to radiation losses, and are represented by the resistor, R, 242 in FIG. 2F.

FIG. 2A shows a simplified drawing of an exemplary magnetic resonator structure. The magnetic resonator may include a loop of conductor acting as an inductive element 202 and a capacitive element 204 at the ends of the conductor loop. The inductor 202 and capacitor 204 of an electromagnetic resonator may be bulk circuit elements, or the inductance and capacitance may be distributed and may result from the way the conductors are formed, shaped, or positioned, in the structure.

For example, the inductor 202 may be realized by shaping a conductor to enclose a surface area, as shown in FIG. 2A. This type of resonator may be referred to as a capacitively-loaded loop inductor. Note that we may use the terms “loop” or “coil” to indicate generally a conducting structure (wire, tube, strip, etc.), enclosing a surface of any shape and dimension, with any number of turns. In FIG. 2A, the enclosed surface area is circular, but the surface may be any of a wide variety of other shapes and sizes and may be designed to achieve certain system performance specifications. In embodiments the inductance may be realized using inductor elements, distributed inductance, networks, arrays, series and parallel combinations of inductors and inductances, and the like. The inductance may be fixed or variable and may be used to vary impedance matching as well as resonant frequency operating conditions.

There are a variety of ways to realize the capacitance required to achieve the desired resonant frequency for a resonator structure. Capacitor plates 204 may be formed and utilized as shown in FIG. 2A, or the capacitance may be distributed and be realized between adjacent windings of a multi-loop conductor. The capacitance may be realized using capacitor elements, distributed capacitance, networks, arrays, series and parallel combinations of capacitances, and the like. The capacitance may be fixed or variable and may be used to vary impedance matching as well as resonant frequency operating conditions.

The inductive elements used in magnetic resonators may contain more than one loop and may spiral inward or outward or up or down or in some combination of directions. In general, the magnetic resonators may have a variety of shapes, sizes and number of turns and they may be composed of a variety of conducing materials. The conductor 210, for example, may be a wire, a Litz wire, a ribbon, a pipe, a trace formed from conducting ink, paint, gels, and the like or from single or multiple traces printed on a circuit board. An exemplary embodiment of a trace pattern on a substrate 208 forming inductive loops is depicted in FIG. 2B.

In embodiments the inductive elements may be formed using magnetic materials of any size, shape thickness, and the like, and of materials with a wide range of permeability and loss values. These magnetic materials may be solid blocks, they may enclose hollow volumes, they may be formed from many smaller pieces of magnetic material tiled and or stacked together, and they may be integrated with conducting sheets or enclosures made from highly conducting materials. Conductors may be wrapped around the magnetic materials to generate the magnetic field. These conductors may be wrapped around one or more than one axis of the structure. Multiple conductors may be wrapped around the magnetic materials and combined in parallel, or in series, or via a switch to form customized near-field patterns and/or to orient the dipole moment of the structure. Examples of resonators comprising magnetic material are depicted in FIGS. 2C, 2D, 2E. In FIG. 2D the resonator comprises loops of conductor 224 wrapped around a core of magnetic material 222 creating a structure that has a magnetic dipole moment 228 that is parallel to the axis of the loops of the conductor 224. The resonator may comprise multiple loops of conductor 216, 212 wrapped in orthogonal directions around the magnetic material 214 forming a resonator with a magnetic dipole moment 218, 220 that may be oriented in more than one direction as depicted in FIG. 2C, depending on how the conductors are driven.

An electromagnetic resonator may have a characteristic, natural, or resonant frequency determined by its physical properties. This resonant frequency is the frequency at which the energy stored by the resonator oscillates between that stored by the electric field, W_{E}, (W_{E}=q²/2C, where q is the charge on the capacitor, C) and that stored by the magnetic field, W_{B}, (W_{B}=Li²/2, where i is the current through the inductor, L) of the resonator. The frequency at which this energy is exchanged may be called the characteristic frequency, the natural frequency, or the resonant frequency of the resonator, and is given by ω,

$$ω = 2 π f = \sqrt{\frac{1}{LC}} .$$

The resonant frequency of the resonator may be changed by tuning the inductance, L, and/or the capacitance, C, of the resonator. In one embodiment system parameters are dynamically adjustable or tunable to achieve as close as possible to optimal operating conditions. However, based on the discussion above, efficient enough energy exchange may be realized even if some system parameters are not variable or components are not capable of dynamic adjustment.

In embodiments a resonator may comprise an inductive element coupled to more than one capacitor arranged in a network of capacitors and circuit elements. In embodiments the coupled network of capacitors and circuit elements may be used to define more than one resonant frequency of the resonator. In embodiments a resonator may be resonant, or partially resonant, at more than one frequency.

In embodiments, a wireless power source may comprise of at least one resonator coil coupled to a power supply, which may be a switching amplifier, such as a class-D amplifier or a class-E amplifier or a combination thereof. In this case, the resonator coil is effectively a power load to the power supply. In embodiments, a wireless power device may comprise of at least one resonator coil coupled to a power load, which may be a switching rectifier, such as a class-D rectifier or a class-E rectifier or a combination thereof. In this case, the resonator coil is effectively a power supply for the power load, and the impedance of the load directly relates also to the work-drainage rate of the load from the resonator coil. The efficiency of power transmission between a power supply and a power load may be impacted by how closely matched the output impedance of the power source is to the input impedance of the load. Power may be delivered to the load at a maximum possible efficiency, when the input impedance of the load is equal to the complex conjugate of the internal impedance of the power supply. Designing the power supply or power load impedance to obtain a maximum power transmission efficiency is often called “impedance matching”, and may also referred to as optimizing the ratio of useful-to-lost powers in the system. Impedance matching may be performed by adding networks or sets of elements such as capacitors, inductors, transformers, switches, resistors, and the like, to form impedance matching networks between a power supply and a power load. In embodiments, mechanical adjustments and changes in element positioning may be used to achieve impedance matching. For varying loads, the impedance matching network may include variable components that are dynamically adjusted to ensure that the impedance at the power supply terminals looking towards the load and the characteristic impedance of the power supply remain substantially complex conjugates of each other, even in dynamic environments and operating scenarios.

In embodiments, impedance matching may be accomplished by tuning the duty cycle, and/or the phase, and/or the frequency of the driving signal of the power supply or by tuning a physical component within the power supply, such as a capacitor. Such a tuning mechanism may be advantageous because it may allow impedance matching between a power supply and a load without the use of a tunable impedance matching network, or with a simplified tunable impedance matching network, such as one that has fewer tunable components for example. In embodiments, tuning the duty cycle, and/or frequency, and/or phase of the driving signal to a power supply may yield a dynamic impedance matching system with an extended tuning range or precision, with higher power, voltage and/or current capabilities, with faster electronic control, with fewer external components, and the like.

In some wireless energy transfer systems the parameters of the resonator such as the inductance may be affected by environmental conditions such as surrounding objects, temperature, orientation, number and position of other resonators and the like. Changes in operating parameters of the resonators may change certain system parameters, such as the efficiency of transferred power in the wireless energy transfer. For example, high-conductivity materials located near a resonator may shift the resonant frequency of a resonator and detune it from other resonant objects. In some embodiments, a resonator feedback mechanism is employed that corrects its frequency by changing a reactive element (e.g., an inductive element or capacitive element). In order to achieve acceptable matching conditions, at least some of the system parameters may need to be dynamically adjustable or tunable. All the system parameters may be dynamically adjustable or tunable to achieve approximately the optimal operating conditions. However, efficient enough energy exchange may be realized even if all or some system parameters are not variable. In some examples, at least some of the devices may not be dynamically adjusted. In some examples, at least some of the sources may not be dynamically adjusted. In some examples, at least some of the intermediate resonators may not be dynamically adjusted. In some examples, none of the system parameters may be dynamically adjusted.

In some embodiments changes in parameters of components may be mitigated by selecting components with characteristics that change in a complimentary or opposite way or direction when subjected to differences in operating environment or operating point. In embodiments, a system may be designed with components, such as capacitors, that have an opposite dependence or parameter fluctuation due to temperature, power levels, frequency, and the like. In some embodiments, the component values as a function of temperature may be stored in a look-up table in a system microcontroller and the reading from a temperature sensor may be used in the system control feedback loop to adjust other parameters to compensate for the temperature induced component value changes.

In some embodiments the changes in parameter values of components may be compensated with active tuning circuits comprising tunable components. Circuits that monitor the operating environment and operating point of components and system may be integrated in the design. The monitoring circuits may provide the signals necessary to actively compensate for changes in parameters of components. For example, a temperature reading may be used to calculate expected changes in, or to indicate previously measured values of, capacitance of the system allowing compensation by switching in other capacitors or tuning capacitors to maintain the desired capacitance over a range of temperatures. In embodiments, the RF amplifier switching waveforms may be adjusted to compensate for component value or load changes in the system. In some embodiments the changes in parameters of components may be compensated with active cooling, heating, active environment conditioning, and the like.

The parameter measurement circuitry may measure or monitor certain power, voltage, and current, signals in the system, and processors or control circuits may adjust certain settings or operating parameters based on those measurements. In addition the magnitude and phase of voltage and current signals, and the magnitude of the power signals, throughout the system may be accessed to measure or monitor the system performance. The measured signals referred to throughout this disclosure may be any combination of port parameter signals, as well as voltage signals, current signals, power signals, temperatures signals and the like. These parameters may be measured using analog or digital techniques, they may be sampled and processed, and they may be digitized or converted using a number of known analog and digital processing techniques. In embodiments, preset values of certain measured quantities are loaded in a system controller or memory location and used in various feedback and control loops. In embodiments, any combination of measured, monitored, and/or preset signals may be used in feedback circuits or systems to control the operation of the resonators and/or the system.

Adjustment algorithms may be used to adjust the frequency, Q, and/or impedance of the magnetic resonators. The algorithms may take as inputs reference signals related to the degree of deviation from a desired operating point for the system and may output correction or control signals related to that deviation that control variable or tunable elements of the system to bring the system back towards the desired operating point or points. The reference signals for the magnetic resonators may be acquired while the resonators are exchanging power in a wireless power transmission system, or they may be switched out of the circuit during system operation. Corrections to the system may be applied or performed continuously, periodically, upon a threshold crossing, digitally, using analog methods, and the like.

In embodiments, lossy extraneous materials and objects may introduce potential reductions in efficiencies by absorbing the magnetic and/or electric energy of the resonators of the wireless power transmission system. Those impacts may be mitigated in various embodiments by positioning resonators to minimize the effects of the lossy extraneous materials and objects and by placing structural field shaping elements (e.g., conductive structures, plates and sheets, magnetic material structures, plates and sheets, and combinations thereof) to minimize their effect.

One way to reduce the impact of lossy materials on a resonator is to use high-conductivity materials, magnetic materials, or combinations thereof to shape the resonator fields such that they avoid the lossy objects. In an exemplary embodiment, a layered structure of high-conductivity material and magnetic material may tailor, shape, direct, reorient, etc. the resonator's electromagnetic fields so that they avoid lossy objects in their vicinity by deflecting the fields. FIG. 2D shows a top view of a resonator with a sheet of conductor 226 below the magnetic material that may be used to tailor the fields of the resonator so that they avoid lossy objects that may be below the sheet of conductor 226. The layer or sheet of good 226 conductor may comprise any high conductivity materials such as copper, silver, aluminum, as may be most appropriate for a given application. In certain embodiments, the layer or sheet of good conductor is thicker than the skin depth of the conductor at the resonator operating frequency. The conductor sheet may be preferably larger than the size of the resonator, extending beyond the physical extent of the resonator.

In environments and systems where the amount of power being transmitted could present a safety hazard to a person or animal that may intrude into the active field volume, safety measures may be included in the system. In embodiments where power levels require particularized safety measures, the packaging, structure, materials, and the like of the resonators may be designed to provide a spacing or “keep away” zone from the conducting loops in the magnetic resonator. To provide further protection, high-Q resonators and power and control circuitry may be located in enclosures that confine high voltages or currents to within the enclosure, that protect the resonators and electrical components from weather, moisture, sand, dust, and other external elements, as well as from impacts, vibrations, scrapes, explosions, and other types of mechanical shock. Such enclosures call for attention to various factors such as thermal dissipation to maintain an acceptable operating temperature range for the electrical components and the resonator. In embodiments, enclosure may be constructed of non-lossy materials such as composites, plastics, wood, concrete, and the like and may be used to provide a minimum distance from lossy objects to the resonator components. A minimum separation distance from lossy objects or environments which may include metal objects, salt water, oil and the like, may improve the efficiency of wireless energy transfer. In embodiments, a “keep away” zone may be used to increase the perturbed Q of a resonator or system of resonators. In embodiments a minimum separation distance may provide for a more reliable or more constant operating parameters of the resonators.

In embodiments, resonators and their respective sensor and control circuitry may have various levels of integration with other electronic and control systems and subsystems. In some embodiments the power and control circuitry and the device resonators are completely separate modules or enclosures with minimal integration to existing systems, providing a power output and a control and diagnostics interface. In some embodiments a device is configured to house a resonator and circuit assembly in a cavity inside the enclosure, or integrated into the housing or enclosure of the device.

### Wireless Power Repeater Resonators

A wireless power transfer system may incorporate a repeater resonator configured to exchange energy with one or more source resonators, device resonators, or additional repeater resonators. A repeater resonator may be used to extend the range of wireless power transfer. A repeater resonator may be used to change, distribute, concentrate, enhance, and the like, the magnetic field generated by a source. A repeater resonator may be used to guide magnetic fields of a source resonator around lossy and/or metallic objects that might otherwise block the magnetic field. A repeater resonator may be used to eliminate or reduce areas of low power transfer, or areas of low magnetic field around a source. A repeater resonator may be used to improve the coupling efficiency between a source and a target device resonator or resonators, and may be used to improve the coupling between resonators with different orientations, or whose dipole moments are not favorably aligned.

An oscillating magnetic field produced by a source magnetic resonator can cause electrical currents in the conductor part of the repeater resonator. These electrical currents may create their own magnetic field as they oscillate in the resonator thereby extending or changing the magnetic field area or the magnetic field distribution of the source.

In embodiments, a repeater resonator may operate as a source for one or more device resonators. In other embodiments, a device resonator may simultaneously receive a magnetic field and repeat a magnetic field. In still other embodiments, a resonator may alternate between operating as a source resonator, device resonator or repeater resonator. The alternation may be achieved through time multiplexing, frequency multiplexing, self-tuning, or through a centralized control algorithm. In embodiments, multiple repeater resonators may be positioned in an area and tuned in and out of resonance to achieve a spatially varying magnetic field. In embodiments, a local area of strong magnetic field may be created by an array of resonators, and the positioned of the strong field area may be moved around by changing electrical components or operating characteristics of the resonators in the array.

In embodiments a repeater resonator may be a capacitively loaded loop magnetic resonator. In embodiments a repeater resonator may be a capacitively loaded loop magnetic resonator wrapper around magnetic material. In embodiments the repeater resonator may be tuned to have a resonant frequency that is substantially equal to that of the frequency of a source or device or at least one other repeater resonator with which the repeater resonator is designed to interact or couple. In other embodiments the repeater resonator may be detuned to have a resonant frequency that is substantially greater than, or substantially less than the frequency of a source or device or at least one other repeater resonator with which the repeater resonator is designed to interact or couple. Preferably, the repeater resonator may be a high-Q magnetic resonator with an intrinsic quality factor, Qᵣ, of 100 or more. In some embodiments the repeater resonator may have quality factor of less than 100. In some embodiments, \sqrt{QₛQᵣ}>100. In other embodiments, \sqrt{Q_{d}Qᵣ}>100. In still other embodiments, \sqrt{Qᵣ₁Qᵣ₂}>100.

In embodiments, the repeater resonator may include only the inductive and capacitive components that comprise the resonator without any additional circuitry, for connecting to sources, loads, controllers, monitors, control circuitry and the like. In some embodiments the repeater resonator may include additional control circuitry, tuning circuitry, measurement circuitry, or monitoring circuitry. Additional circuitry may be used to monitor the voltages, currents, phase, inductance, capacitance, and the like of the repeater resonator. The measured parameters of the repeater resonator may be used to adjust or tune the repeater resonator. A controller or a microcontroller may be used by the repeater resonator to actively adjust the capacitance, resonant frequency, inductance, resistance, and the like of the repeater resonator. A tunable repeater resonator may be necessary to prevent the repeater resonator from exceeding its voltage, current, temperature, or power limits. A repeater resonator may for example detune its resonant frequency to reduce the amount of power transferred to the repeater resonator, or to modulate or control how much power is transferred to other devices or resonators that couple to the repeater resonator.

In some embodiments the power and control circuitry of the repeater resonators may be powered by the energy captured by the repeater resonator. The repeater resonator may include AC to DC, AC to AC, or DC to DC converters and regulators to provide power to the control or monitoring circuitry. In some embodiments the repeater resonator may include an additional energy storage component such as a battery or a super capacitor to supply power to the power and control circuitry during momentary or extended periods of wireless power transfer interruptions. The battery, super capacitor, or other power storage component may be periodically or continuously recharged during normal operation when the repeater resonator is within range of any wireless power source.

In some embodiments the repeater resonator may include communication or signaling capability such as WiFi, Bluetooth, near field, and the like that may be used to coordinate power transfer from a source or multiple sources to a specific location or device or to multiple locations or devices. Repeater resonators spread across a location may be signaled to selectively tune or detune from a specific resonant frequency to extend the magnetic field from a source to a specific location, area, or device. Multiple repeater resonators may be used to selectively tune, or detune, or relay power from a source to specific areas or devices.

The repeater resonators may include a device into which some, most, or all of the energy transferred or captured from the source to the repeater resonator may be available for use. The repeater resonator may provide power to one or more electric or electronic devices while relaying or extending the range of the source. In some embodiments low power consumption devices such as lights, LEDs, displays, sensors, and the like may be part of the repeater resonator.

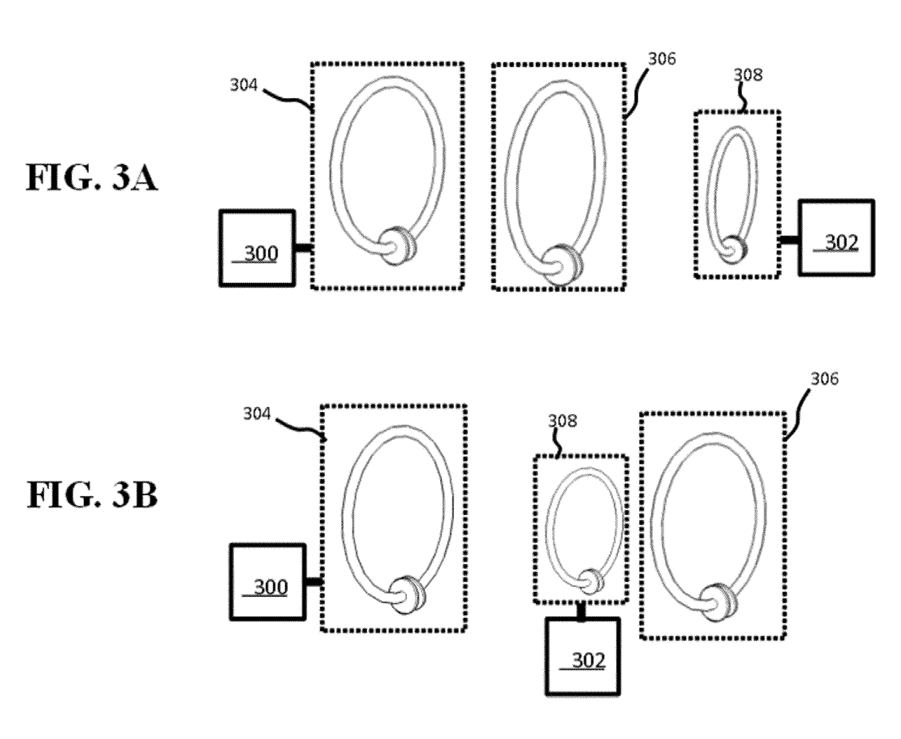

Several possible usage configurations are shown in FIGS. 3-5 showing example arrangements of a wireless power transfer system that includes a source 304 resonator coupled to a power source 300, a device resonator 308 coupled to a device 302, and a repeater resonator 306. In some embodiments, a repeater resonator may be used between the source and the device resonator to extend the range of the source. In some embodiments the repeater resonator may be positioned after, and further away from the source than the device resonator as shown in FIG. 3B. For the configuration shown in FIG. 3B more efficient power transfer between the source and the device may be possible compared to if no repeater resonator was used. In embodiments of the configuration shown in FIG. 3B it may be preferable for the repeater resonator to be larger than the device resonator.

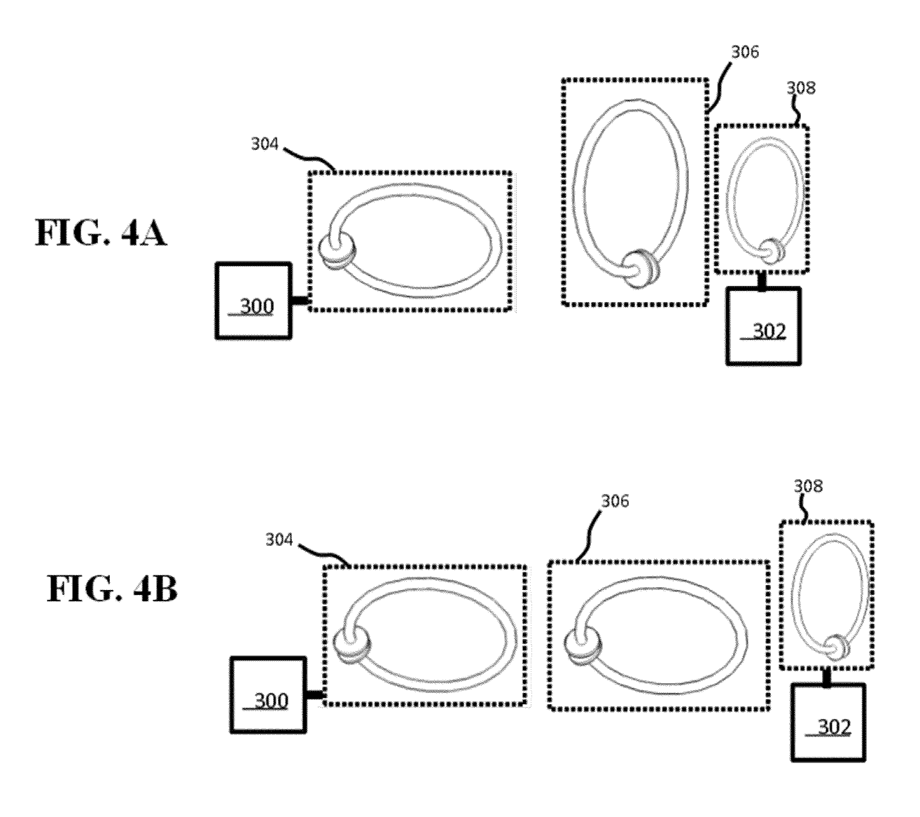

In some embodiments a repeater resonator may be used to improve coupling between non-coaxial resonators or resonators whose dipole moments are not aligned for high coupling factors or energy transfer efficiencies. For example, a repeater resonator may be used to enhance coupling between a source and a device resonator that are not coaxially aligned by placing the repeater resonator between the source and device aligning it with the device resonator as shown in FIG. 4A or aligning with the source resonator as shown in FIG. 4B.

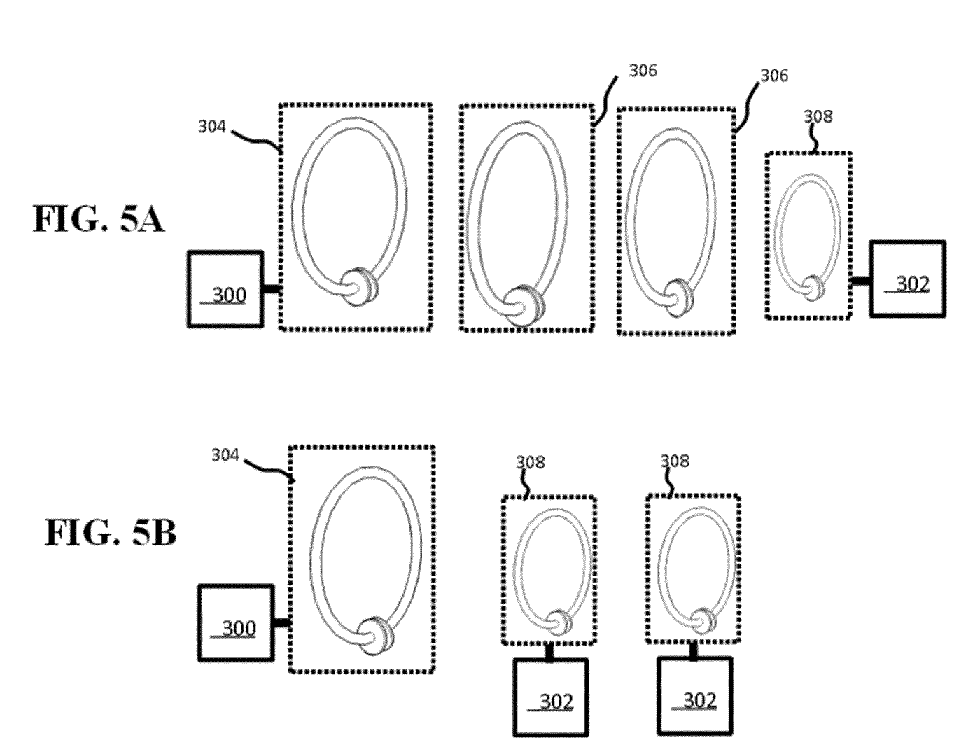

In some embodiments multiple repeater resonators may be used to extend the wireless power transfer into multiple directions or multiple repeater resonators may one after another to extend the power transfer distance as shown in FIG. 5A. In some embodiments, a device resonator that is connected to load or electronic device may operate simultaneously, or alternately as a repeater resonator for another device, repeater resonator, or device resonator as shown in FIG. 5B. Note that there is no theoretical limit to the number of resonators that may be used in a given system or operating scenario, but there may be practical issues that make a certain number of resonators a preferred embodiment. For example, system cost considerations may constrain the number of resonators that may be used in a certain application. System size or integration considerations may constrain the size of resonators used in certain applications.

In some embodiments the repeater resonator may have dimensions, size, or configuration that is the same as the source or device resonators. In some embodiments the repeater resonator may have dimensions, size, or configuration that is different than the source or device resonators. The repeater resonator may have a characteristic size that is larger than the device resonator or larger than the source resonator, or larger than both. A larger repeater resonator may improve the coupling between the source and the repeater resonator at a larger separation distance between the source and the device.

In some embodiments two or more repeater resonators may be used in a wireless power transfer system. In some embodiments two or more repeater resonators with two or more sources or devices may be used.

### Repeater Resonator Modes of Operation

A repeater resonator may be used to enhance or improve wireless power transfer from a source to one or more resonators built into electronics that may be powered or charged on top of, next to, or inside of tables, desks, shelves, cabinets, beds, television stands, and other furniture, structures, and/or containers. A repeater resonator may be used to generate an energized surface, volume, or area on or next to furniture, structures, and/or containers, without requiring any wired electrical connections to a power source. A repeater resonator may be used to improve the coupling and wireless power transfer between a source that may be outside of the furniture, structures, and/or containers, and one or more devices in the vicinity of the furniture, structures, and/or containers.

In some embodiments the power source and source resonator may be built into walls, floors, dividers, ceilings, partitions, wall coverings, floor coverings, and the like. A piece of furniture comprising a repeater resonator may be energized by positioning the furniture and the repeater resonator close to the wall, floor, ceiling, partition, wall covering, floor covering, and the like that includes the power source and source resonator. When close to the source resonator, and configured to have substantially the same resonant frequency as the source resonator, the repeater resonator may couple to the source resonator via oscillating magnetic fields generated by the source. The oscillating magnetic fields produce oscillating currents in the conductor loops of the repeater resonator generating an oscillating magnetic field, thereby extending, expanding, reorienting, concentrating, or changing the range or direction of the magnetic field generated by the power source and source resonator alone. The furniture including the repeater resonator may be effectively “plugged in” or energized and capable of providing wireless power to devices on top, below, or next to the furniture by placing the furniture next to the wall, floor, ceiling, etc. housing the power source and source resonator without requiring any physical wires or wired electrical connections between the furniture and the power source and source resonator. Wireless power from the repeater resonator may be supplied to device resonators and electronic devices in the vicinity of the repeater resonator. Power sources may include, but are not limited to, electrical outlets, the electric grid, generators, solar panels, fuel cells, wind turbines, batteries, super-capacitors and the like.

In embodiments, a repeater resonator may enhance the coupling and the efficiency of wireless power transfer to device resonators of small characteristic size, non-optimal orientation, and/or large separation from a source resonator. As described above in this document, the efficiency of wireless power transfer may be inversely proportional to the separation distance between a source and device resonator, and may be described relative to the characteristic size of the smaller of the source or device resonators.

In embodiments, the repeater resonator may enhance the coupling and the efficiency of wireless power transfer between a source and a device if the dipole moments of the source and device resonators are not aligned or are positioned in non-favorable or non-optimal orientations.

In embodiments the repeater resonator may use a core of magnetic material or use a form of magnetic material and may use conducting surfaces to shape the field of the repeater resonator to improve coupling between the device and source resonators or to shield the repeater resonators from lossy objects that may be part of the furniture, structures, or containers.

In embodiments, the repeater resonator may have power and control circuitry that may tune the resonator or may control and monitor any number of voltages, currents, phases, temperature, fields, and the like within the resonator and outside the resonator. The repeater resonator and the power and control circuitry may be configured to provide one or more modes of operation. The mode of operation of the repeater resonator may be configured to act only as repeater resonator. In other embodiments the mode of operation of the repeater resonator may be configured to act as a repeater resonator and/or as a source resonator. The repeater resonator may have an optional power cable or connector allowing connection to a power source such as an electrical outlet providing an energy source for the amplifiers of the power and control circuits for driving the repeater resonator turning it into a source if, for example, a source resonator is not functioning or is not in the vicinity of the furniture. In other embodiments the repeater resonator may have a third mode of operation in which it may also act as a device resonator providing a connection or a plug for connecting electrical or electronic devices to receive DC or AC power captured by the repeater resonator. In embodiments these modes be selected by the user or may be automatically selected by the power and control circuitry of the repeater resonator based on the availability of a source magnetic field, electrical power connection, or a device connection.

In embodiments the repeater resonator may be designed to operate with any number of source resonators that are integrated into walls, floors, other objects or structures. The repeater resonators may be configured to operate with sources that are retrofitted, hung, or suspended permanently or temporarily from walls, furniture, ceilings and the like.

Although the use of a repeater resonator with furniture has been described with the an exemplary embodiment depicting a table and table top devices it should be clear to those skilled in the art that the same configurations and designs may be used and deployed in a number of similar configurations, furniture articles, and devices. For example, a repeater resonator may be integrated into a television or a media stand or a cabinet such that when the cabinet or stand is placed close to a source the repeater resonator is able to transfer enough energy to power or recharge electronic devices on the stand or cabinet such as a television, movie players, remote controls, speakers, and the like.

In embodiments the repeater resonator may be integrated into a bucket or chest that can be used to store electronics, electronic toys, remote controls, game controllers, and the like. When the chest or bucket is positioned close to a source the repeater resonator may enhance power transfer from the source to the devices inside the chest or bucket with built in device resonators to allow recharging of the batteries.

It is to be understood that the exemplary embodiments described and shown having a repeater resonator were limited to a single repeater resonator in the discussions to simplify the descriptions. All the examples may be extended to having multiple devices or repeater resonators with different active modes of operation.

### Wireless Power Transfer in Footwear Applications

The methods and systems disclosed herein can be used to wirelessly transfer power to footwear. For example, one or more of the resonators described herein in relation to FIGS. 1-5 can be connected to or integrated in footwear such as shoes, ski boots, slippers, and the like. Energy may be transferred to the resonators in the footwear while the footwear is worn by a user or stored. Energy may be wirelessly transferred to the resonators of the footwear while the footwear is moving, stationary, and in various positions and/or orientations. Energy may be transferred to the footwear without the footwear being physically connected to a power outlet through an electrical wire.

Energy captured by the resonators of the footwear may be used to provide temperature or climate control for the footwear. In some embodiments, the footwear may include a heating element for heating the inside or outside of the footwear. The heating element may be positioned to provide heating to specific regions of the foot such as the toes, midsole, heel, ankle, or other parts. In some cases, the heating elements may be positioned to provide heating to multiple areas of the footwear. The heating elements may be energized by energy captured by device resonators that may be integrated or attached to the footwear.

Energy capture resonators (e.g. device resonators), and electronics, may be integrated into the soles of the footwear, or over the toes of the footwear, or on the tongue of the footwear, or within or attached to any portion of the footwear. Device resonators and electronics may be attached or integrated into the insoles, toe area, heel area, or other locations. The resonators may be configured to receive energy from other resonators (e.g. source resonators, repeater resonators) via oscillating magnetic fields as described herein.

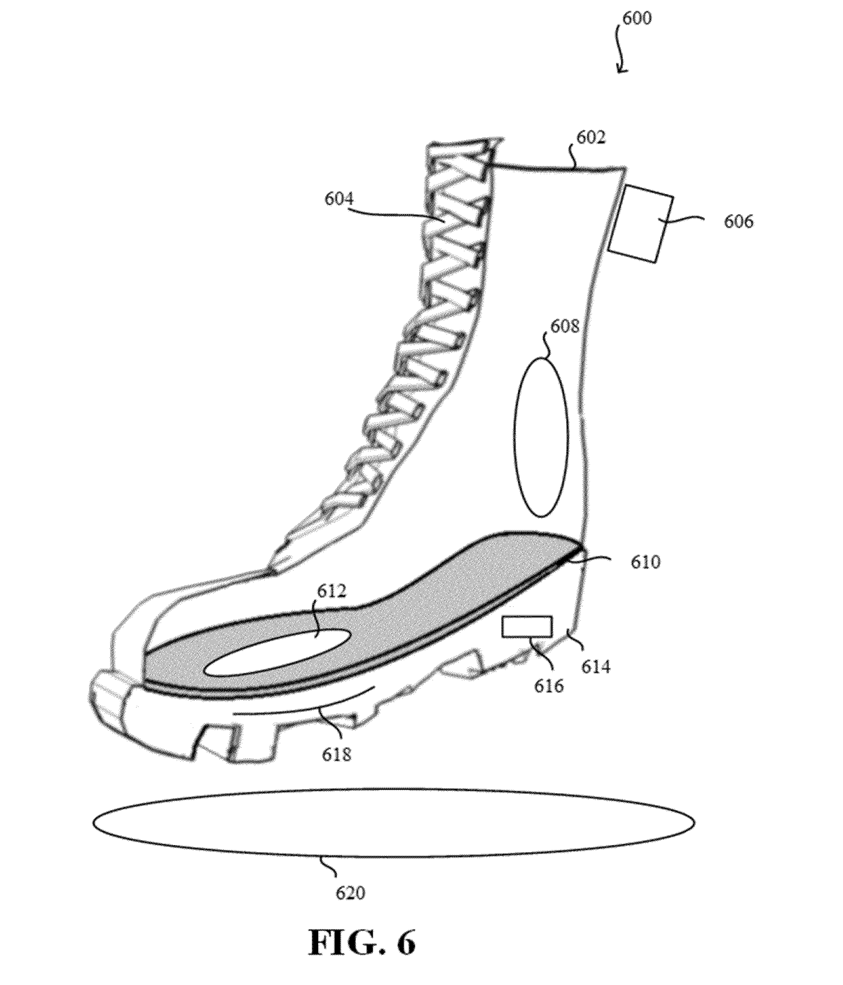

FIG. 6 shows a cross section of boot with system for providing wireless heating to the boot. The system 600 may include footwear 602 that may include one or more resonators 608, 618, and one or more heating elements 612. These resonators may be device resonators or repeater resonators. Energy may be transferred to the resonators 608, 618 from one or more wireless energy sources 620 that may be positioned outside the footwear. Wireless energy sources may include a source resonator and source power and control electronics. The wireless source 620 may be coupled to a power supply such as the AC mains, a battery, a solar panel, a generator, and the like.

Resonators 608, 618 may be positioned or located in various locations in the footwear. As depicted in the FIG. 6, resonators may be integrated into the sole of the footwear. In some embodiments, the resonators may be integrated into the insole 610 or the outer shell of the footwear. In some cases, the resonators may be removable. In some embodiments, they may be attached to a removable insole 610 or liner that may be inserted or attached to a variety of footwear.

Footwear may include electronics such as power electronics, control electronics, and/or sensors. The electronics may be connected, coupled wirelessly and/or positioned next to the device resonators. In some embodiments, the device electronics may be in a different location than the device resonators and/or heating elements of the footwear. The electronics 616, for example, may be integrated into the sole or heel 614 of the footwear or positioned outside the footwear in a box or module 606 and wired or wirelessly connected to the heating element and the resonators.

In some embodiments, the device resonators may be integrated into the fabric or structure of the footwear. Electrically conductive thread, for example, may be woven, stitched or attached to elements of the footwear. Conductive thread, comprising silver, carbon, gold, copper, aluminum, or other electrically conductive materials may be stitched onto parts of the footwear. The thread stitching may be arranged to form one or more loops that may be used as a resonator coil. In some embodiments, elements of the footwear such as the shoelaces 604, straps, or the like may include electrically conductive thread, wires, or the like and may be used as resonator coils of the system 600.

Heating elements 612 may be positioned in various locations of the footwear. The heating elements may be electrically resistive elements that may produce or generate heat when electricity is passed through the elements. In some embodiments, the heating element and the device resonator may share common components. In some embodiments, parts of the resonator or resonator coil may include elements that may generate heat when exposed to electrical currents or magnetic fields. Electrically resistive elements and metallic elements comprising metals such as iron, steel, and the like may be part of the device resonator or near the resonator and generate heat when the device resonator is energized by an external source resonator.

In some embodiments, heating elements may include Peltier devices or other devices that may use magnetic energy and/or electrical energy captured by the device resonator to generate heat. In some embodiments, wireless power transfer systems may be combined with power generating or recovery systems using pressure sensors, piezoelectric transducers (PZTs) and the like, that may also supply power to the devices of the footwear. In embodiments, these additional power supplying systems may be used when the footwear is not in the vicinity of wireless power sources, repeaters and capture devices. In other embodiments, the additional power supplying systems may be used in conjunction with the wireless power systems and may supply additional power to the footwear system.

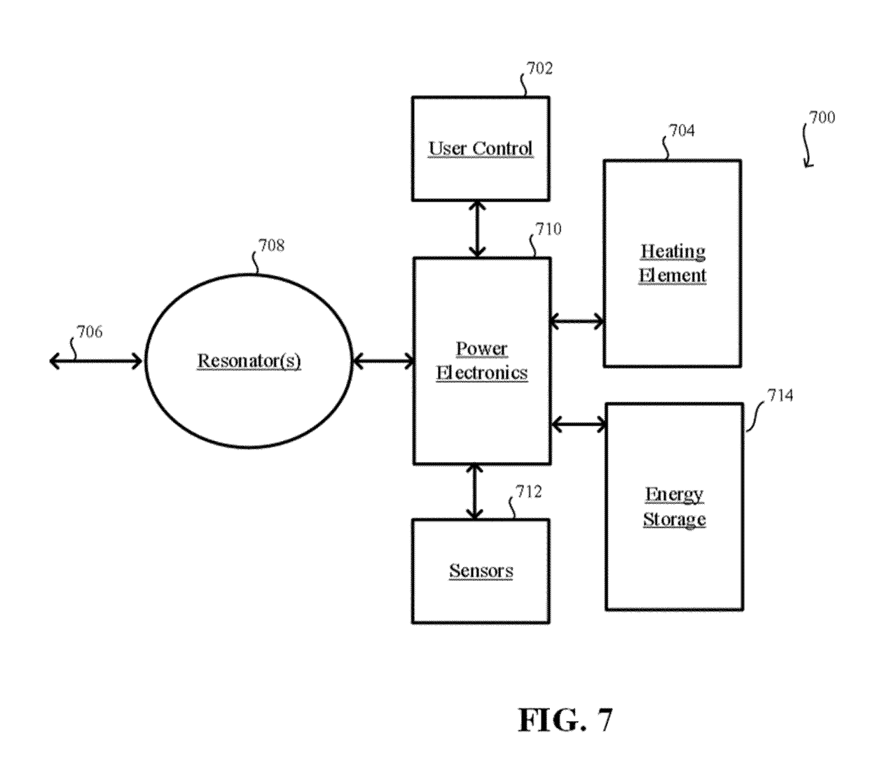

FIG. 7 shows a block diagram of the components of one embodiment of a footwear system 700 with wireless energy transfer. The system 700 may include one or more resonators 708 that may receive energy 706 from an external source via oscillating magnetic fields. The parameters of the resonator may be controlled by power electronics 710. The power electronics may monitor the voltages, currents, operating frequency, temperature, and the like of the resonator and adjust parameters such as capacitance, resistance, inductance, rectification, switching frequency, or other parameters to adjust operating conditions. In some embodiments, the power electronics 710 may include rectifiers, voltage/current clamps, switches, and the like. In some embodiments, the output of the power electronics 710 may be a rectified DC output. In some embodiments, the output may be an AC output with a frequency that may be different than the frequency of the resonator. The output of the power electronics may be used by a heating element 704. The heating element may take as input electrical energy from the power electronics 710 and generate thermal energy or heat.

In embodiments, the system may include user control 702. The user control 702 may include an interface such as buttons, dials, or indicators relating to the operation of the system 700. The user control 702 may further provide the user an interface for controlling aspects of the system. The user may be able to turn off the system, increase a temperature setting, decrease the temperature setting. In some embodiments, the user control 702 may include logic and hardware enabling remote control. The user control 702 may include a wireless communication module for connecting to a remote device such as a tablet, phone, kiosk, or the like. The remote device may include an interface such as a graphical interface that may be used to communicate settings to the user control 702.

The system 700 may also include sensors 712 such as temperature sensors, position sensors, moisture sensors, pressure sensors, and the like. The sensors may include feedback logic for allowing for self control and regulation of the parameters of the resonator and power electronics to maintain a set temperature, temperature profile, or other parameters inside the footwear.

In some embodiments, the system 700 may also include an energy storage element 714. The energy storage element may be a battery or a capacitor that may store electrical energy. Electrical energy may be stored in the element 714 and used at a later time to power a heating element 704 or other elements of the system 700. In embodiments, the battery may be a wirelessly rechargeable battery. The battery may include its own device resonator. The wireless battery may be removable and rechargeable apart from the footwear. For example, the wireless battery may be charged at a home, at a business, or another location that is equipped to wirelessly charge the battery. The wireless battery may be attached to footwear where it may power the foot warmer through a wired or wireless connection. The battery of the footwear may also be charged using any known techniques such as wired recharging, inductive recharging and the like. In some embodiments, the battery may be a disposable battery. In other embodiments, the storage element may be a capacitive storage element. In still other embodiments, the storage element may be a chemical energy storage element, a solid state energy solid state element, a fuel cell, or any known energy storage element.

In embodiments, the system may comprise a thermal storage medium such as a phase change material. This thermal storage medium may function to store energy that may be used as a heat source. For example, the phase change material may be encased in ferrous materials such as cast iron and made to be a part of the footwear or insert. While the wirelessly charging footwear is charged, the phase change material could be melted and as it freezes, could release energy in the form of heat. Alternatively, the thermal storage material could be in a single state of matter such as solid or liquid. Thermal storage may effectively prolong the heating time for the footwear. In some embodiments, the phase change material may be covered in a hard casing and integrated into the volume of the footwear. This material may or may not be removable. This material may be integrated into the footwear at the time of manufacture of the footwear. In some embodiments, the phase change material may be heated via a wired or wireless connection.

In embodiments, the system sensors 712 of the system may be configured to control the operation of the system. In some systems, the heating elements may be configured to be operational when the footwear is worn by the user. In such applications, pressure sensors, light sensors, or other sensors may be used detect that the footwear is worn by a user. In some embodiments, the system may be configured to be operational when not worn by the user. Footwear may be configured to receive power and activate the heating elements to dry the footwear when not worn by the user. Pressure sensors may determine the presence of a person's foot and control the activation element to maintain a temperature. Additional moisture sensors may be used to determine if the footwear has reached satisfactory dryness. In some embodiments, a footwear system may include different modes of operation depending on if the footwear is worn by a user. Pressure sensors, for example, may be used to determine if a user is wearing the footwear and adjust the mode accordingly. In some embodiments, sensors may also comprise power harvesting capabilities. For example, pressure sensors may be able to sense pressure and also recover energy from pressure applied to the sensor and/or an energy harvesting unit.

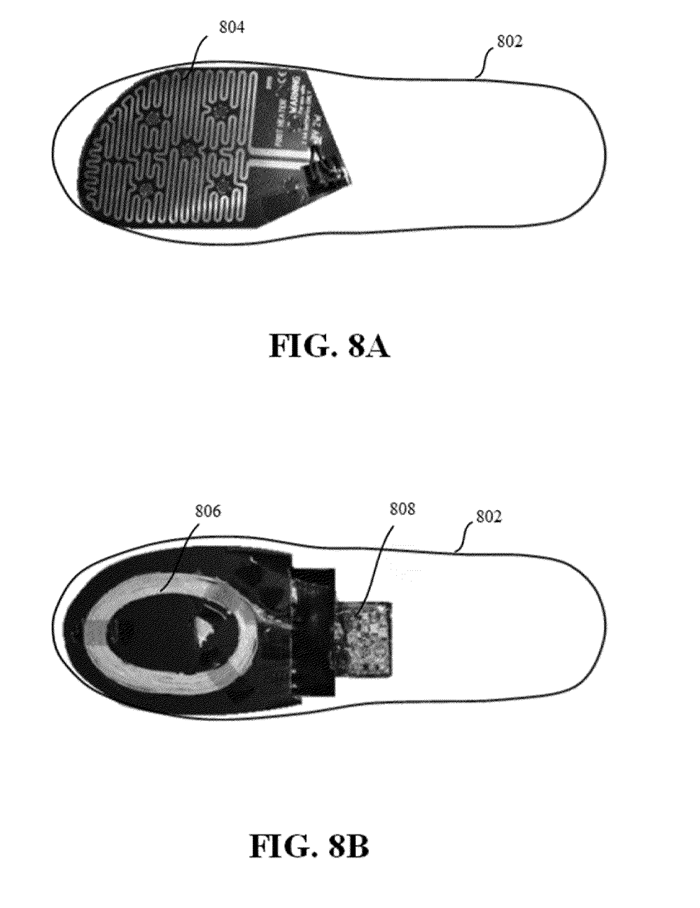

In some applications, the energy transfer and heating system may be integrated into an insole or insert. An insole or insert may be easily replaced and retrofitted into a large array of footwear types. FIG. 8A shows the top of an exemplary wireless footwear insole 802. The top of the insole 802 may be configured with a heating element such as a resistive load 804 that may generate thermal energy or heat when exposed to an electric current. FIG. 8B shows the bottom of an exemplary wireless footwear insole 802. The bottom may be fitted with a device resonator coil 806 and device electronics 808. The device electronics 808 may include components such as capacitors and control logic. The energy captured by the device resonator may be converted to electrical energy and used to energize the heating elements on top of the insole.

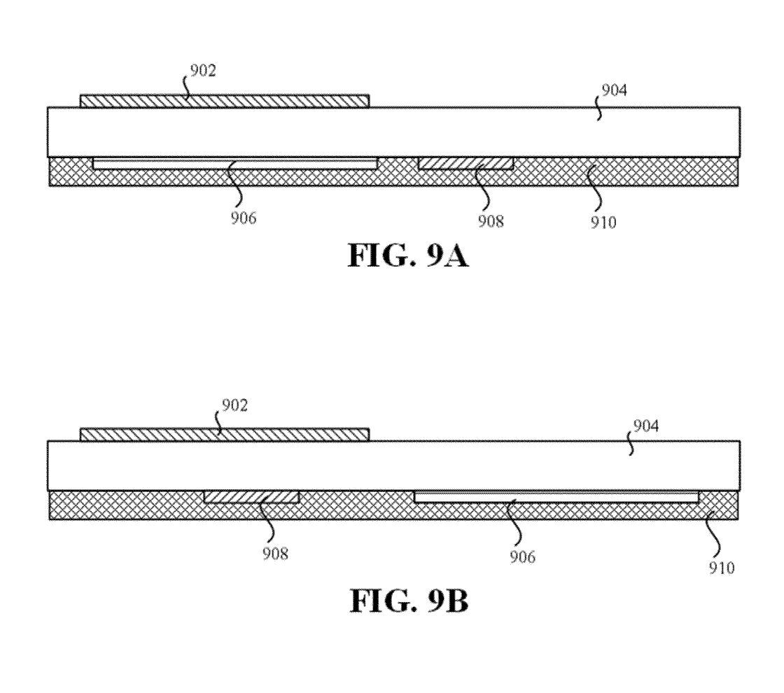

FIG. 9A shows a cross section of one embodiment of a wireless insole. The wireless insole may include an inside core 904 of non-lossy material. The inside core 904 may comprise traditional insole material such as leather, foam, plastic, or other materials or combinations of materials. A heating element 902 may be attached to the top of the core 904. The heating element may be a resistive heating element that may be printed, adhered, woven into, stitched, or the like on top of the core. The heating element may span the whole length of the insole core 904 or may be strategically positioned in specific areas of the insole such as towards the toe section for example. One or more device resonators 906 may be positioned on the underside of the core 904. Electronics such as power electronics and/or control logic may also be positioned on the underside of the core 904. Positioning the resonators and/or electronics on the underside may provide a smoother, more comfortable surface for a person's foot on top of the insole. Likewise, positioning the resonator and electronics on the underside of the core 904 positions the resonator closer to the ground surface when inserted into footwear. In many applications, source resonators may be integrated into the ground surface. A closer spacing may result in improved energy transfer efficiency. The device resonator 906 may be wired or inductively coupled to the electronics 908 and the electronics may be electrically connected or inductively coupled to the heating element 902. In some embodiments, additional material 910 may be used to encapsulate or cover the resonator and electronics to improve durability. In embodiments, the encapsulation may enable any part of the footwear to be washed or immersed in water.

In some embodiments, the relative location of the resonator coil and the heating element may have an impact on the overall energy transfer efficiency of the system. In the case where the heating element may be a resistive element such as a resistive metal, it may be preferable to position the device resonator away from the heating element or reduce the overlap between the two components. FIG. 9B depicts an alternative configuration to FIG. 9A. In the exemplary configuration of FIG. 9B, the device resonator 906 is positioned away from the heating element 902 such that the device resonator is not directly under the heating element 902.

A wireless insole may utilize any number of resonator types described herein. The type of resonator used in the insole may depend on the applications, cost, and expected orientation and position of the source during operation. In many applications, a resonator structure with a flat or planar shape may be preferable such that it may be integrated into an insole without adding substantial thickness. In some applications, the resonators with a dipole moment that is orthogonal to the bottom surface of the insole may be most appropriate. Applications that may rely on source resonators integrated into flooring, for example, may require resonators with a dipole moment that is orthogonal to the bottom of the insole. In many embodiments, 1 Watt or 7.5 Watt or more of power may be delivered to the heating element of the footwear insole.

In some embodiments, each insole may be configured or adjusted to provide the desired amount of heat. In some cases, the insoles may be preconfigured to provide different amounts of heat. The insoles may be configured for various applications or customer preferences to generate relatively low, medium, or high heat when used under the same conditions. The amount of heat produced by an insole may be controlled by the size/type of heating element. In some embodiments, the amount of heat generated by an insole during operation may be controlled by tuning of the device resonator in the footwear. Device resonators may be tuned to different frequencies relative to the operating frequency of the energy transfer system. Insoles that are configured for low heat may have resonators that are detuned (1 kHz or more) from operating frequency of the energy transfer system. Insoles that are configured for high heat may have resonators that are tuned close (within 1 kHz) to the operating frequency of the energy transfer system.

In embodiments, the system may comprise various methods of temperature feedback, control, and/or compensation. Such embodiments include but are not limited to passive thermal disconnects, active thermal disconnects, in-band communications, out-of-band communications, local thermal control, regional thermal control, heat estimation, energy estimation, bang-bang (on/off) control, or other digital or analog forms of control methods.

In some embodiments, the wireless footwear may include electronic components that may change parameters in response to changes in their temperature. The electronic components may be coupled to the heating elements and/or resonators and may change the operating parameters of the heating element and/or the resonator as the temperature of the footwear increases or decreases. In one example, a capacitor may be attached to the resonator of the footwear. The capacitor may be configured to at least in part define the resonant frequency of the resonator. The capacitance of the capacitor may change as function of the temperature of the capacitor. In some embodiments, the capacitance of the capacitor may increase as the temperature increases. In some embodiments, the capacitance may decrease with increased temperature. The nominal value of the capacitance may be selected to ensure a resonant frequency of the resonator equal or similar to that of the wireless energy transfer system. When energy is transferred to the footwear and the temperature of the footwear increases the resonant frequency of the resonator may change as a result of the changes to the capacitance of the capacitor. The change in resonant frequency may reduce the efficiency of energy transfer and may cause a reduction in heating in the footwear. The temperature of the footwear may as a result be self-regulating. As the temperature increases, the resonator may be naturally detuned by changes in the parameters of the elements which may decrease the efficiency of energy transfer to the footwear. As the temperature in the footwear decreases, the resonator may be tuned back to its nominal frequency and may receive more energy thereby increasing the temperature.

In embodiments, components such as capacitors, inductors, resistors with temperature dependent parameters may be used to change the resonant frequency of the device resonator in the footwear.

In many footwear applications, efficiency of wireless energy transfer between source resonators and a device resonator in the footwear or the insole of the footwear may be improved with repeater resonators. In some embodiments, footwear may be integrated with repeater resonators. Footwear may be designed as “wireless ready” and may have a repeater resonator that is integrated into the footwear. A user wishing to enable wireless energy transfer to the footwear may purchase insoles with a device resonator and a specific function (e.g. heating, monitoring steps taken, fitness monitoring) and insert the insole into the footwear. The repeater resonator may be integrated into the sole of the footwear or other parts of the footwear. The repeater resonator may be larger than the resonator of an insole. With repeater resonators integrated into “wireless ready” footwear, smaller device resonators may be used in the insoles. The repeater resonators may not require any wired connections to any components of the footwear.

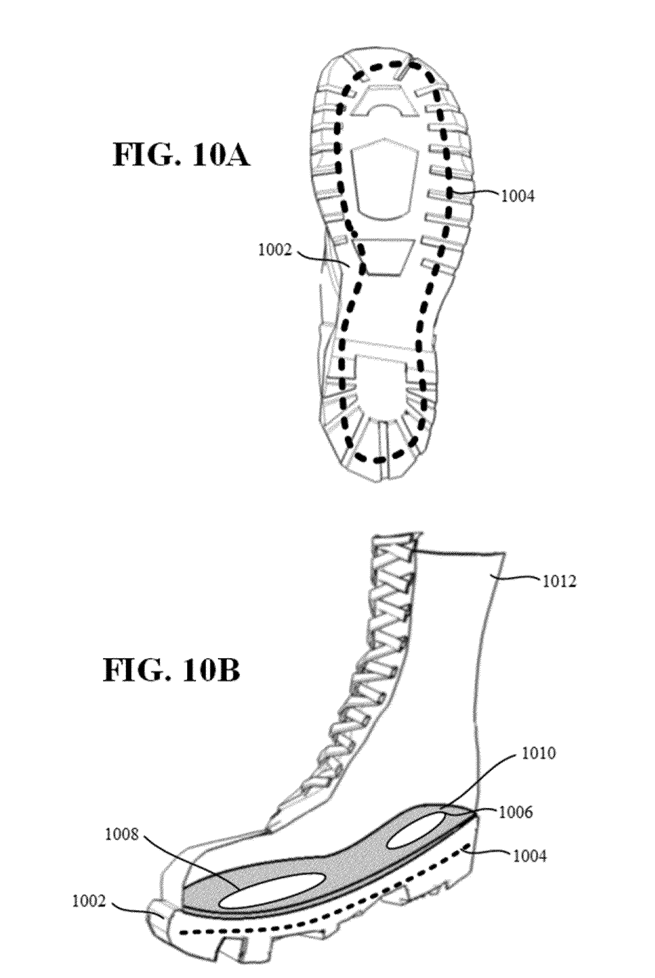

FIG. 10A shows one configuration of a repeater resonator in an embodiment of a wireless ready boot. The figure shows the bottom of the boot. A repeater resonator 1004 may be integrated into the sole 1002 of the boot. The repeater resonator 1004 may be shaped or positioned to maximize the size of the resonator or maximize the size of the loop of the resonator coil. A resonator coil of the resonator 1004 may be shaped to follow the contours of the boot. The repeater resonator may be positioned and configured to have dipole moment that is perpendicular to the bottom of the boot. Components of the resonators such as capacitors, fuses, and/or other components may be positioned inside the sole. The repeater resonator may be completely sealed inside the sole or other parts of the boot. The repeater resonator may be integrated into the fabric, or in parts of the boot.

A wireless ready boot may be configured to accept additional modules with device resonators. Additional modules may include functional insoles, attachments, gadgets, sensors, and the like. Additional modules may have resonators that are smaller than the repeater resonator of the wireless ready footwear. For example, insoles with wireless device resonators with heating elements may be inserted into the wireless ready boot. The insoles may have smaller device resonators. The device resonators may couple to the repeater resonators during operation of the system. FIG. 10B shows one configuration of an embodiment of a wireless ready boot with a functional insole. The figure shows a cross section of a boot 1012. The boot 1012 may be wireless ready and have a repeater resonator integrated or attached to one of its members. In one example, the repeater resonator 1004 may be integrated into the bottom sole 1002 of the boot. A functional insole 1010 may be inserted into the boot 1004. The insole may be tailored to different applications and may include heating capability, sensing capability, and the like. Insoles may include one or more device resonators and electronics 1006 for receiving wireless energy. The energy may be received via the repeater resonator 1004. Energy received by the device resonator 1006 to energize a heating element 1008 of the insole 1010. The device resonator 1006 of the insole may, in some embodiments, be relatively smaller than the repeater resonator 1004 of the boot 1012. Users of a wireless ready boot may insert different insoles depending on the preferred function. Insoles designated for wireless ready boots may anticipate the presence of a repeater resonator and may be tuned to receive energy via the repeater resonator.

In embodiments, wirelessly powered heated footwear may receive energy from the source while being worn by a user. Footwear with wirelessly powered functionality or devices, such as heating may be activated when the footwear is near a source of wireless power.

In embodiments, wireless power sources may be installed or integrated into many environments and applications. Wireless source may be deployed in vehicles. Resonators may be positioned in foot wells and located near or in floor mats. The source resonators in a vehicle may be positioned to transfer energy to footwear. The footwear may be configured to receive the energy and generate heat inside the footwear. Control of the source in the vehicle may be coupled to the climate control of the vehicle. The source resonators, may in some embodiments, automatically turn on when the heating system of the vehicle is activated. The amount of power transmitted by the sources may be proportional or related to the heater settings of the vehicle. Delivery of energy for heating of a passenger's feet may be an efficient way of providing climate control in electric or hybrid vehicles. Wirelessly heated footwear may be desirable for open vehicles such as motorcycles which may not have heating of any kind Source resonators may be located near a rider's feet to transfer energy from the motorcycle to the rider's boot.

In embodiments, a wireless energy source for wirelessly powered footwear may be integrated into mats or floor materials in residences, hotels, spas, offices, and the like. A source may be integrated into furniture such as a bed, couch, ottoman, chair, carpet, cushions, blankets, and the like. The source may transfer energy to wirelessly powered footwear such as shoes, slippers, socks, insoles, and the like. In some embodiments, a source may be activated by nearby footwear and may regulate its power level by determining the number and power draw of devices or footwear to power.

In some embodiments, a wireless energy source installation may be interactive and/or advertisement supported. A designated area may be near a transit stop, venue, or other locations. An ad may be displayed when the user enters the wireless area. Designated areas may be marked and as designated wireless warming area for wirelessly heated footwear. Users with wireless footwear may be encouraged to congregate around a wireless source to receive energy. Wireless sources may create “hot spots” and may be used to entice people into stores, restaurants, etc., as is currently done with WiFi hotspots. Users may purchase wireless power plans so that they can activate the device resonators in their footwear when they travel. Any of the previously described methods for pairing wireless sources and devices, including those described in US. Published Patent Application published on Mar. 15, 2012 as US2012/0062345A1 and incorporated here by reference, may be used to initiate, restrict, charge for, and the like, wireless power transfer to worn device resonators.

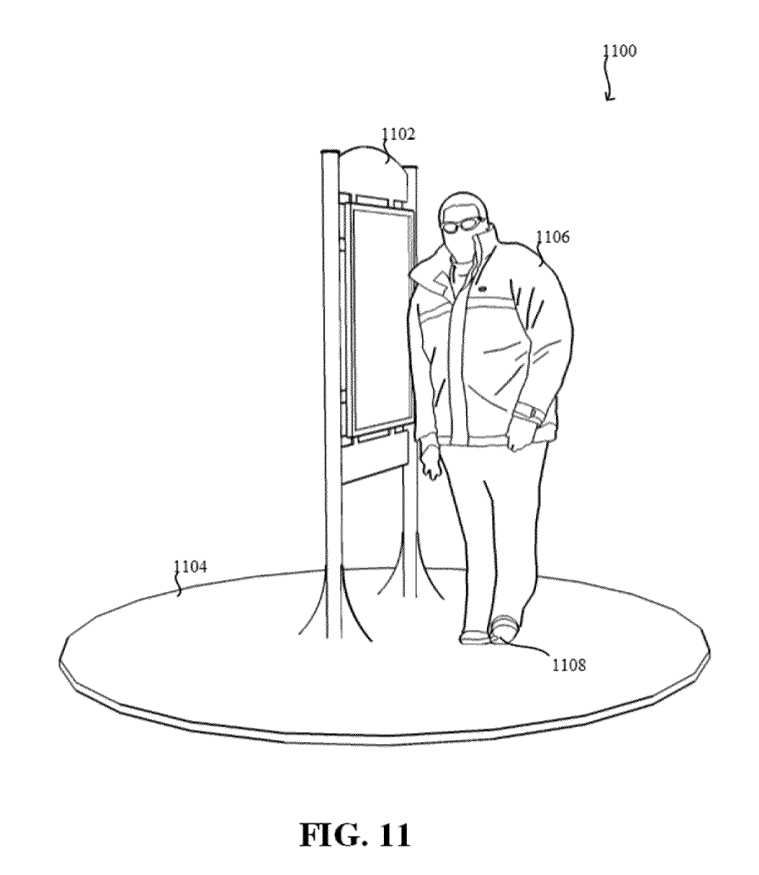

FIG. 11 shows one embodiments of a wireless energy source installation 1100. The installation 1100 may include a display or identification sign 1102 and a wireless energy area 1104 around or near the sign 1102. The wireless energy area 1102 may include one or more source resonators that generate oscillating magnetic fields. Energy from the sources may be captured by device resonators that may be part of footwear 1108 worn by a user 1106.

In embodiments, the sign 1102 of the installation 1100 may include advertisements such as video advertisements or interactive displays to attract users, provide information, or provide control or adjustment for the user's device resonators and device electronics. In embodiments, the sign 1102, energy area 1104, or other parts of the installation 1100 may include sensors or detectors for identifying users and/or verifying their authorization to the source. In some installations 1100, pressure sensors and/or proximity sensors may be used to detect a user entering or standing in the energy area 1104. When a user is detected in the area, the wireless energy sources may be energized in the area or part of the area 1104 where a user 1106 is standing or located. In some installations or applications, the installation 1100 may detect compatibility of the device resonators and electronics. The installation may determine if the user is authorized to receive energy from the installation. The installation may communicate with one or more remote systems to determine authorization information.

In some embodiments, in order to activate or maintain energy transfer from the installation 1100, the user may be required to interact with marketing content on the installation. The user may be required to watch an advertisement or answer a question to maintain energy transfer.

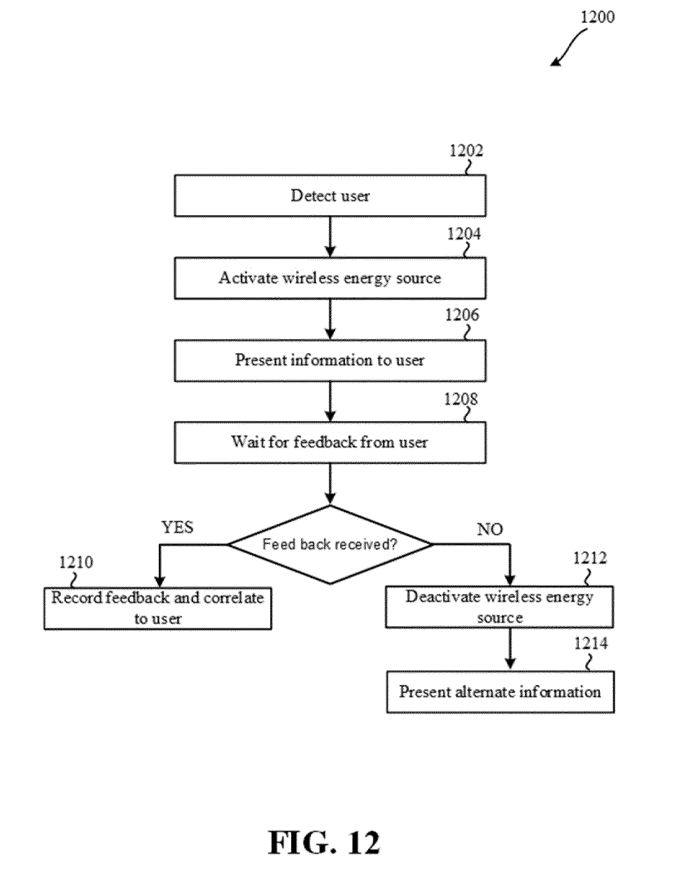

FIG. 12 shows one embodiment of a method 1200 for operating a wireless source installation. In step 1202 of the method 1200, the installation may detect a user. A user may be detected using one or more sensors such as pressure sensors, proximity sensors, using wireless communication protocols, source resonators, and the like. When the user is detected the wireless energy source may be activated in step 1204. In some cases, a source may be activated to transfer energy only in the vicinity of the user. The location of the user may be identified using the sensors and appropriate source resonators and/or repeater resonators from a multiplicity of source and/or repeater resonators may be activated to provide energy only around the user and not in other parts of the source installation where users may not be present. In step 1206, the user may be presented with information such as marketing material. In some cases, the user may be presented with controls for controlling the energy transfer. In some embodiments, the user may be prompted to enter an authorization code or other identifiers. In step 1208, feedback from the user may be expected based on the marketing content or other inquiries presented to the user. In some cases, the user may be required to respond to the inquiry to maintain energy transfer. If the user provides feedback, in step 1210 the energy transfer may continue and the feedback from the user may be saved and correlated to the specific user. If the user does not provide feedback after a time threshold, say, a minute or more, the wireless energy source may be deactivated in step 1212. In step 1214, alternative content or inquiry may be made to the user prompting the user to provide feedback. Once the user provides feedback, the wireless energy source may be reactivated.

Wireless energy source installations and wireless footwear may be practical in outdoor locations or applications such as ski resorts. Wireless power sources may be installed in ski lift lines, on ski lifts, outside ski lodges, in ski gondolas, lodges, food or beverage kiosks, benches, bathrooms and the like. Ski boots or other footwear may include a wirelessly powered heater. When a skier with a boot outfitted with a wirelessly powered warmer is near the source, that skier's boots may warm up. For example, a “warming lane” in one of the ski lift lines or other hot-spots such as paths, lanes, tracks, and the like comprising wirelessly powered sources and/or repeaters could be created for those that want to warm their feet, recharge consumer electronics, warm other resistive heaters placed on a person or in their clothes (such as a jacket, hat, pants, gloves, etc.).

In embodiments, equipment suppliers, infrastructure providers, and ski area managers installing and offering the foot-warming hot-spots may do so on either a free or on a pay-per-use basis to improve the ski area experience or lure customers into strategic areas both indoors and outdoors. Ski areas may rent or sell wirelessly powered ski insoles for use by customers. Wireless warming insoles may be provided to customers when they buy lift tickets or season passes. The system can be tuned to a separate and distinct frequency specific to the ski area, and if desired, skiers may be charged use fees by the day or season much like the cell phone subscription model. In embodiments, the wireless energy transfer technology can be standardized across all boot OEMs (original equipment manufacturers) and ski areas.

In embodiments, glove warmers may be configured for wireless power transfer as has been described above for foot warmers. In addition, warming/cooling modules or packs, comprising a wireless receiver and a warming/cooling unit and an energy storage unit may be designed as a stand-alone unit that may be easily picked up and placed down for temporary warming and/or cooling of parts of the body. In an exemplary embodiment, a warming/cooling module may be encapsulated in a flexible container so that it looks and feels similar to the “Hot Hands” warming packs that are currently commercially available. These packs are suitable for being held in a hand, or inserted into a glove or a mitten. Wirelessly rechargeable heating/cooling packs could be picked up by a user and placed in their hand, or glove, or pocket, or hat, or placed next to any part of the body that requires warming/cooling. When the battery ran out, the user could place the pack on a wireless power source or in wireless power bin to be recharged. In places, such as ski resorts, where users may need to recharge the battery packs of the heating/cooling units more than once per day, the packs could be exchanged, so that a user could drop off a pack that needed to be recharged in exchange for pick up a fully rechargeable pack. For applications where warming/cooling packs will be shared by multiple people, it may be advantageous to have packaged these wirelessly power/charged heating/cooling packs in a way that they can be easily cleaned, sanitized, sterilized and the like. In embodiments, the wireless heating/cooling packs may be packaged in waterproof packaging. In embodiments, the wireless heating/cooling packs may be packed in flexible packaging. In embodiments, warming/cooling packs may be packaged in packaging that looks and feels similar to disposable products such as “Hot Hands” packs, “Dr. Scholls” insoles. In embodiments, warming/cooling packs may be packaged in packaging that is designed to approximately follow some portion of the contour of the human body.

Although examples and embodiments described herein were mainly directed to footwear with wireless heating, it is to be understood the methods, systems, and designs described herein may be used for other footwear and clothing applications. For example, in addition to heating, cooling to the footwear may be provided using Peltier devices. Heating and cooling may be used in medical or therapeutic applications. Wireless footwear, bandages, or other clothing may be used provide wireless heating and cooling according to a thermal profile that may advantageous for injury recovery or other therapeutic applications. The therapeutic footwear or other devices may be powered wirelessly from a source that may be part of furniture, floors, hospital beds, other equipment.

In embodiments, warming and/or cooling elements may be places anywhere on a user's body or in any clothing or items worn by a user. By way of example, but not limitation, wirelessly power warming/cooling devices may be places in pants, shirts, underwear, sports gear, helmets, pockets, gloves, back-packs, scarves, head-phones and the like. In addition, while the invention has been described primarily as providing power to heating and/or warming elements, it should be understood that power could be supplied to a variety of devices, all of which should be considered part of the invention. For example, wirelessly coupled power could be supplied to person-worn electronics such as monitors including fitness monitors, heart monitors, pulse monitors, breathing monitors, step monitors, blood-pressure monitors, diabetes monitors, oxygen monitors, motion monitors, temperatures monitors, location monitors and the like. Wirelessly coupled power may also be provided to watches, cell phones, displays, rings, eye-wear, lights, head phones, therapeutic devices and the like whenever such devices are worn by the user or placed in pockets, pouches, bags, compartments and the like or help by straps, buttons, buckles and the like in the vicinity of the person. The invention is intended to cover any of these use case scenarios and the other capabilities such as regulating power exchange and the like may be applied to any of these systems.

In embodiments, the system could be used to capture power from a wireless power source and transfer power wirelessly or using wires to other places on the body. For example, wireless power could be transmitted to a user's boot and then the insole may be wired to recharge a central battery or fuel cell carried by the user. In another example, a wireless power resonator may be built into the hem of a pants leg to receive power from a source on a ground, and that received power may be distributed to one of more positions on the user's body using additional wireless power transfer components, wired components, or any combination of the two.

In embodiments, any and all of the technologies used for foreign object debris (FOD) detection and living object detection (LOD) such as described in at least U.S. Published Patent Application published on Mar. 21, 2013 as US2013/0069441A1 and U.S. Published Patent Application published on Apr. 24, 2014 as US2014/0111019A1, incorporated here in their entirety by reference, may be combined with the inventions described here to provide additional safety and control systems to the wireless power transfer system.

While the invention has been described in connection with certain preferred embodiments, other embodiments will be understood by one of ordinary skill in the art and are intended to fall within the scope of this disclosure, which is to be interpreted in the broadest sense allowable by law.

### Wirelessly Powered Card

Resonators and electronics may be integrated or located inside of cards, including but not limited to credit cards, debit cards, business cards, access cards, gift cards, rewards card, meal cards, identification cards, appointment cards, membership cards, library cards, hotel key cards, and the like. A wirelessly powered or charged card may be self-contained with no wired connections between the card and the source of power. A wirelessly powered or charged card may comprise a regular USB drive, micro-USB drive, other memory device and the like. A wirelessly powered or charged card may comprise a magnetic strip that could be used for transactions such as swiping to pay for something, swiping to exchange information, swiping to gain access or entry, etc. A wirelessly powered or charged card may comprise a wireless communication facility that may be used to transmit and/or receive information that may be used to execute payments, to track usage, to receive promotions, to activate locks, lights, computers and the like. The wireless communication may be used to allow the card to communicate with computational devices such as phones, tablets, computers, registers, controllers, vehicles and the like. Applications, also called “apps” may be designed to interact with and monitor, report on, and/or control the wirelessly power or charged card. A wirelessly powered or charged card may also be configured as a wireless power source that could extract energy from devices and use the extracted energy to generate an oscillating magnetic field.

The wirelessly powered card may have a variety of functions related to personal information, finance, commerce, marketing, security, etc. The wirelessly powered card may comprise a high-Q resonator, including resonator inductors and capacitors, and/or impedance matching components and/or power conditioning components and the like, and could be used as part of a wireless power transmission system. The wirelessly powered card may operate as a wireless power repeater.

The wirelessly powered card may be made thin enough to retain a similar shape of a regular credit card, debit card, gift card, business card, access card, ID card, and the like. The wirelessly powered card may operate as a wireless power source and/or a wireless power device and/or a wireless power repeater. The wirelessly powered card may simultaneously support multiple wireless modes of operation. The wirelessly powered card may exchange power and information wirelessly. The wirelessly powered card may comprise a display, a screen, a touch pad, a readout, visual indicators, decorations, actuators, and the like.

The wirelessly powered card may receive power from a wireless source that is specifically tuned to the card's frequency. The card's specific resonator frequency may be changed depending on the need for power or any other parameter control or restriction.

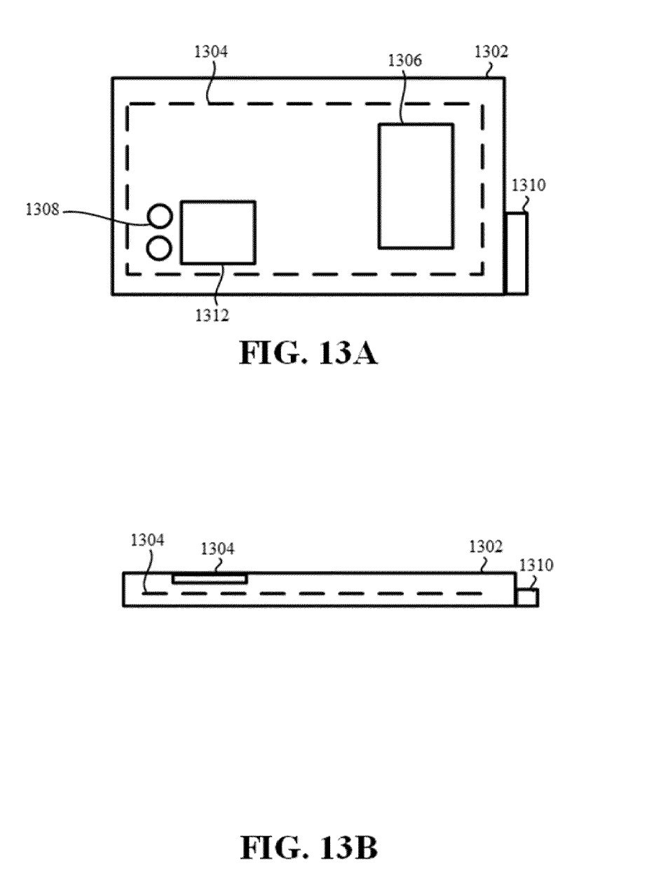

FIG. 13A shows a diagram of an embodiment of wirelessly charged multi-use card. The card may include a connector 1310 such as a USB, micro USB, lightning or other electronic connector. Resonators 1304 and electronics 1312 may be embedded in the card 1302. The resonator 1304 and electronics 1312 may be thin and may be completely embedded in a thin enclosure with dimensions similar to a credit card, an access card, a wireless ID card, a business card, and the like. In preferred embodiments, a wirelessly powered card may be thinner than 2 mm or less than 1 mm. The cross-sectional area of the inductive element of the wireless power combo card may be similar to a credit card, to a business card, and/or to any commonly carried card.

The card may include electronics that enable both wired and wireless information transfer via the remote control or USB drive. The card may include buttons 1308 and other input devices. In some cases, output devices, such as lights, displays 1306 may be included in the card.

In some embodiments, a wirelessly powered card may be designed and/or programmed to be distinctive and visually appealing according to one's tastes. For example, a card may be modular and may allow a user to attach or insert LEDs, small mirrors, bangles, charms and the like to decorate their card. The LEDs may be programmed to blink, to turn on in sequence, to spell words and the like. The wirelessly powered cards may be programmed to customize the look and feel of the card. The wirelessly powered cards may also be heated and may be used as hand warmers, foot warmers, and the like. The wirelessly powered cards may also be designed to function as lights, flashlights, hot plates, cold plates, alarms, indicators, and the like. In some embodiments, the wirelessly powered card may have a decorative shape and may include a cut-out for attaching the card to a chain, a ring, a key-ring, a bracelet, a necklace, a zipper, and the like.

In some embodiments, the wirelessly powered card may have a magnetic strip with a substantially similar functionality to the magnetic strip on a credit card, debit card, gift card, rewards card, access card, and the like. The wirelessly powered card may have a USB connector, a mini-USB connector, and/or a micro-USB connector that that is connected to electronic memory on the card. For example, the combo card may comprise memory, saved information or programs, and the like. In embodiments, the card may comprise an inductive coil for wirelessly coupling to devices using a traditional inductive charging system. For example, the card may be used to receive power wirelessly at one frequency, say 6.78 MHz for example, and to provide power at a different frequency, such as in the range of 100 kHz to 300 kHz. In embodiments, the card may be configured to provide power conversion functionality, such as described in U.S. Published Patent Application published on Oct. 21, 2010 as US2010/0264747A1, and U.S. Published Patent Application published on Oct. 4, 2012 as US2012/0245981A1, incorporated in its entirety herein by reference. For example, the card may be used to receive power from a source according to one wireless standard or protocol and convert it to wireless power for powering a device designed to receive wireless power using a different standard or protocol. In an exemplary embodiment, a card may be placed on a Qi compatible source and may generated an oscillating magnetic field that may be used to power an A4WP compatible device.

In some embodiments, the wirelessly powered card may also have a display screen 1306 that may display information related to the owner of the card or information that is transmitted wirelessly to the card. For example, the card may display the promotions of the issuer of the card or the business that the card is connected to. In another example, the card may display a security code (such as an RSA security code).

In some embodiments, the wirelessly powered card may also work as an identification card that stores personal information that is required to gain access to an account, a secured area, a machine, and the like.

In some embodiments, the wirelessly powered card may also function as a business card that utilizes the transferred wireless energy to display a business logo, contact information, and the like. The transferred wireless energy may also heat a resistive element that may result in visual change (such as changing the colors on the face of a card) to the card.

In some embodiments, the wirelessly powered card may function as a rechargeable battery that may have a connector to charge an electronic device or that may be coupled inductively to a rechargeable battery.

In some embodiments, the wirelessly powered card may function as a remote control device to control an electronic device wirelessly. The card may have press buttons, switches, slide buttons, touch pads, touch screens, and the like to allow the user to control the card as a remote.

In some embodiments, the wirelessly powered card may function as an appointment card that would remind the user as to a specific time, date, place, etc. relating to the appointment. The card may be made of a material that would enable it to be written on by a pencil, pen, marker, or other writing implement. In embodiments, the material may be erasable and/or cleanable. The wirelessly powered card may be in a shape that could fit in a particular or customized space or enclosure in another device. The card may be configured such that the act of inserting or placing the card in its customized space would power the device it is held in or start a sequence to exchange information, power, etc.

In some embodiments, the wirelessly powered card may have a speaker integrated into the card. In some embodiments, the card may be configured to emit a sound for a specific purpose, such as a sound of particular frequency or loudness that may be audible to particular animals, to test the auditory ability of a human, etc.

In some embodiments, the wirelessly powered card may have ports that would be available for wired connectors, USB connectors (both regular and micro), and the like.

In some embodiments, the wirelessly powered card may comprise a keypad that would be used to key in a code for security purposes. In some embodiments, the card may transmit the code to another device using a wired or wireless connection.

The various functions and configurations of the card may be supported by energy captured by one or more device resonators 1304 of the card. Energy captured by a resonator 1304 may be used to power lights, displays, and other electronics such as micro-processors, communication electronics, and the like.

FIG. 13B shows a cross section of an embodiment of wirelessly charged or powered multi-use card. The resonator coil 1304 of the card may be embedded in the card. The resonator coil may be formed from a thin electrical conductor. The resonator coil may be sized and shaped to follow the contours of the card to maximize the area enclosed by the resonator coil.

In some cases, the electronics of the card may be used to store and process e-currency such as bit-coin or other crypto-currency. A processor or a specialized crypto processor may be needed to perform calculations, encryption, decryption, and other functions for payment or transfer of funds. The processor and peripherals of the card may be powered by energy captured by the device resonator of the card.

In some embodiments, a wirelessly powered card may be a hotel key card. The key card may be configured to be used to access hotel rooms, facilities, lounges, restaurants, and the like. The key card may contain a magnetic strip, RFID chip, mechanical holes, bar code, microchip to gain access via a keycard lock. The hotel key card may be used as a “rewards” card and may have memory and/or transmit customer information via wired or wireless communication (i.e. USB, mini-USB, micro-USB). The hotel key card may be used as a wireless power device to charge electronics such as mobile phones, laptops, and the like. For example, a hotel key card integrated with a resonator and electronics may be connected to a mobile phone via a micro-USB connection. The hotel key card may be then placed near a wireless energy source integrated into a surface in a hotel room, lounge area, restaurant, and the like. In some embodiments, a customer's wirelessly powered key card may uniquely couple with a wireless power source in a hotel room or lounge that the key card provides access to.

### Hearing Aids

Wireless energy transfer may be used to power/charge hearing aids. Personal hearing aids need to be small and light to fit into or around the ear of a person. The size and weight restrictions can limit the size of batteries that can be used. Likewise, the size and weight restrictions of the device can make battery replacement difficult due to the delicacy of the components. The dimensions of the devices and hygiene concerns may make it difficult to integrate additional charging ports to allow wired or electrical contact-based recharging of the batteries.

Resonator coils may be integrated into the hearing aid so that the batteries of the hearing aids can be wirelessly recharged. Then, the hearing aids may be recharged while they are worn or they may be charged intermittently by placing the hearing aids on a wireless power source or in a wireless power box. In embodiments, it may be possible to reduce the size of the necessary batteries because they can be recharged more easily and more often. Then, wireless recharging may enable even smaller hearing aids. Batteries of the hearing aid may be recharged without requiring external connections or charging ports. Charging and device circuitry and a small rechargeable battery may be integrated into a form factor of a conventional hearing aid battery allowing retrofit into existing hearing aids. The battery may be a wirelessly chargeable battery. A wirelessly chargeable battery may be self-contained with no wired connections between the battery and the source of power.

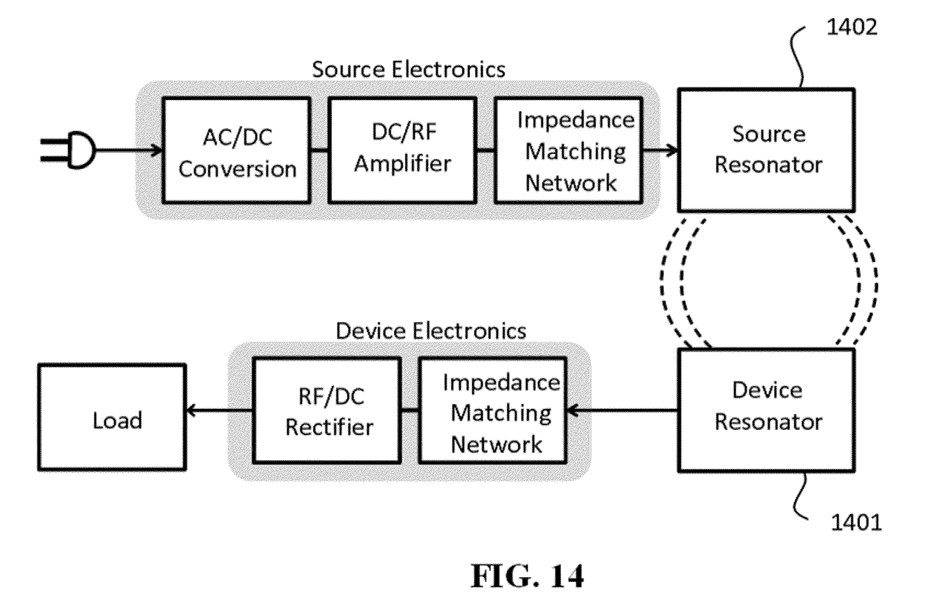

FIG. 14 shows one embodiment of a block diagram of a wirelessly transfer system that may be adapted for hearing aids. The hearing aid may comprise a resonator and battery and electronics. The hearing aid may comprise a resonator that may receive power from a wireless energy source. The power received from the wireless energy source may be used to charge a battery encased in the hearing aid. The battery may be a wirelessly chargeable battery. The wireless energy source may comprise a resonator and electronics. The wireless source may be coupled to a power supply such as AC mains, a battery, a solar panel, a generator, and like.

In some embodiments, a single wireless power source may transfer power to at least one wirelessly powered hearing aid and may transfer power to two, or more than two wirelessly powered hearing aids. The wireless power source may deliver power to the hearing aids in any relative orientation to each other.

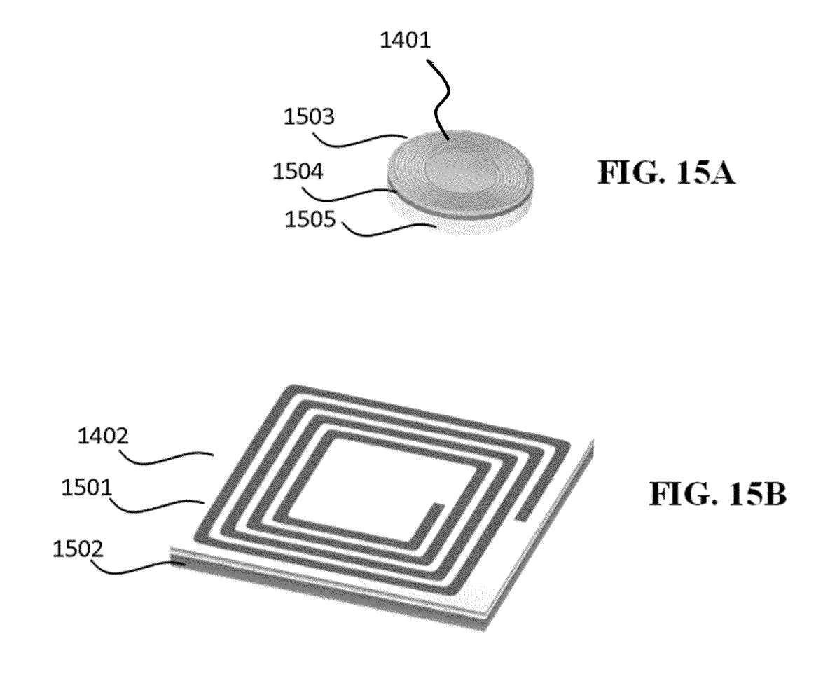

FIGS. 15A and 15B show exemplary embodiments of resonator coils suitable for hearing aid applications. The device resonator coil, shown in FIG. 15A, and the source resonator coil, shown in FIG. 15B, may be used for wireless energy transfer to the hearing aid. In some embodiment, the source resonator coil 1402 may include a printed circuit board coil 1501 and a FJ3 type ferrite 1502. The source resonator coil may be shaped to form four loops.

The hearing aid or device resonator coil 1401 may include a printed circuit board type coil 1503, FJ3 type ferrite 1504, and metal shield 1505. The device resonator coil may be shaped to form more than 1 loop, more than 3 loops, more than 5 loops, more than ten loops, and the like. The wirelessly powered hearing aid system may couple at a frequency of 6.78 MHz. The source may have a power output between 10 and 20 mW. The distance between the source and hearing aid may be 5 mm. The anticipated coupling coefficient, k, may be between 0.01 and 0.1.

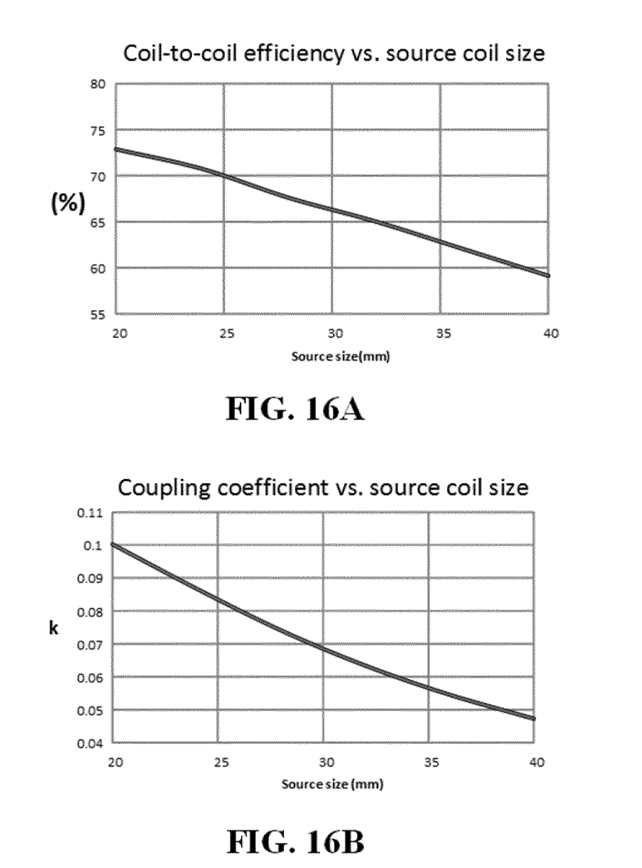

FIG. 16 shows efficiency predictions for an exemplary embodiment of the wirelessly powered hearing aid system similar to that shown in FIG. 15. FIG. 16A shows the calculated coil-to-coil efficiency between a wireless power source and a hearing aid device as the outside diameter of the source coil is varied from 20 to 40 mm. FIG. 16B shows the calculated coupling coefficient, k, of the system as the outside diameter of the source coil is varied from 20 to 40 mm.

In other embodiments, the wirelessly chargeable hearing aid system may consist of more than one separately encased parts. Each of these encased parts may comprise a resonator, electronics, and a battery. In some embodiments, one of the encased parts may act as a passive resonator or repeater that may couple to both the source and the resonators in the other encased parts of the hearing aid. In some embodiments, some encased parts of the hearing aid system may be implanted inside the user's body. In some embodiments, the passive resonator or repeater may be formed to fit over or around the inside or outside of the ear.

In other embodiments, the wirelessly chargeable hearing aid system may comprise implants such as middle-ear implants or cochlear implants. The user may wear the electronics and/or wirelessly charged battery components elsewhere on their body.

In other embodiments, the wireless power source may be encased in a cup or box shape. This cup or box may be shaped to hold a single hearing aid or two hearing aids or more than two hearing aids. In other embodiments, the wirelessly powered hearing aid may be charged while worn by the user. The wireless power source may be integrated into the back of a chair or clothing such as a hat so that the hearing aid may be charged while worn by the user. In some embodiments, source and/or repeater resonators may be built into headphones, ear buds, ear muffs, hats, caps, helmets and the like, and the batteries of the hearing aid may be wirelessly recharged while a person wears any of these devices or articles of clothing.

### Subsea Applications

Unmanned underwater vehicles can autonomously navigate as they collect and process data. Human intervention, however, is sometimes still required to replenish their power supplies. Automatic wireless charging solutions may be used to transfer anywhere from microwatts or milliwatts, to a few watts to kilowatts to hundreds of kilowatts, of power wirelessly to a vehicle such as an unmanned underwater vehicle (UUV).

Highly resonant wireless power transfer can transfer energy through a variety of materials, including water and even saltwater. A wireless energy transfer system, encased in a hermetically sealed enclosure, may transfer power through water while eliminating the need for failure prone wet-mate connectors.

Highly resonant wireless power transfer systems can transfer power efficiently to devices as they move around. Devices such as UUVs may be recharged simply by floating alongside a dock or other platform that has been outfitted with a wireless power source. The high efficiency wireless power transfer between sources and devices with varying relative positions and orientations may remove the need for tight mechanical coupling and may allow for power to be transferred between objects underwater.

FIG. 14 shows exemplary elements of a wireless energy transfer system that could be used for subsea applications. The input power to the system may be AC mains, which is converted to DC in an AC/DC rectifier block, or alternatively, a DC voltage directly from a battery or other DC supply may be used. In high power applications, a power factor correction stage may also be included in this block. A high efficiency switching amplifier may be used to convert the DC voltage into an RF voltage waveform and used to drive the source resonator. An impedance matching network (IMN) may be used to efficiently couple the amplifier output to the source resonator while enabling efficient switching-amplifier operation. Class D or E switching amplifiers may be used in many applications and may require an inductive load impedance for highest efficiency. The IMN may be used to transform the source resonator impedance, loaded by the coupling to the device resonator and output load, into an impedance for the source amplifier. The magnetic field generated by the source resonator may couple to the device resonator, exciting the resonator and causing energy to build up in it. This energy may be coupled out of the device resonator to do useful work, for example, directly powering a load or charging a battery. For loads requiring a DC voltage, a rectifier may be used to convert the received AC power back into DC.

In embodiments, a UUV may be configured to move alongside a larger vessel outfitted with a wireless power source and wirelessly receive power from that source without any direct electrical or docking connections. The source vessel may be, for example, a surface ship, a submarine, or an unmanned floating platform with a form of energy harvesting (such as solar panels) or power generation on-board. A wireless energy transfer system may provide the necessary power to the UUV without the need for docking, mating and other mechanical assemblies.

In one embodiment of the system, a source resonator in a 50 cm×50 cm×3.75 cm enclosure may be used. The device resonator, which may be mounted on the UUV, may be housed in an enclosure that measures 24 cm×27.8 cm×2.2 cm. The system may transfer 3.3 kilowatts of power while meeting IEEE, FCC, and ICNIRP guidelines for human exposure to electric and magnetic fields. A source-device may be positioned with 15 cm of separation.

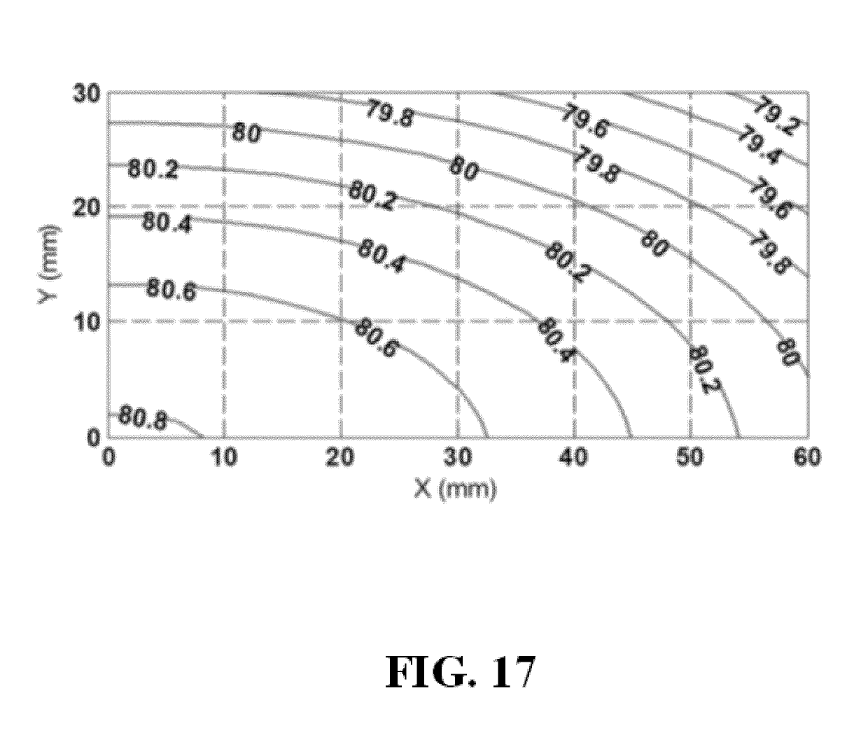

FIG. 17 shows the expected wireless coupling efficiency of the system described above as the device resonator is moved +/−6 cm in the X direction and +/−3 cm in the Y direction relative to the source. The center of the source resonator is defined as (0, 0) and the Z direction captures the separation between the source and device resonators. Over this operating range, the resulting resonator-to-resonator efficiency ranges from 79.2% to 80.8% while transferring 3 kilowatts of power. Note that because of the symmetry of the resonators, the data are only shown for +X and +Y offsets. The solid lines marked with numbers are the contours of constant efficiency for the number displayed (e.g. 80.8%, 80.6%, etc.). The efficiencies in FIG. 17 are the wireless efficiencies which do not include losses due to any necessary stages of power conversion, RF amplification, and AC rectification.

### Conductive Ink Resonator Coils

In embodiments, resonator coils may be made using conductive inks or other printable conductive material. Conductive ink may be transferred to a substrate via a printer, pen, spray, brush, and the like.

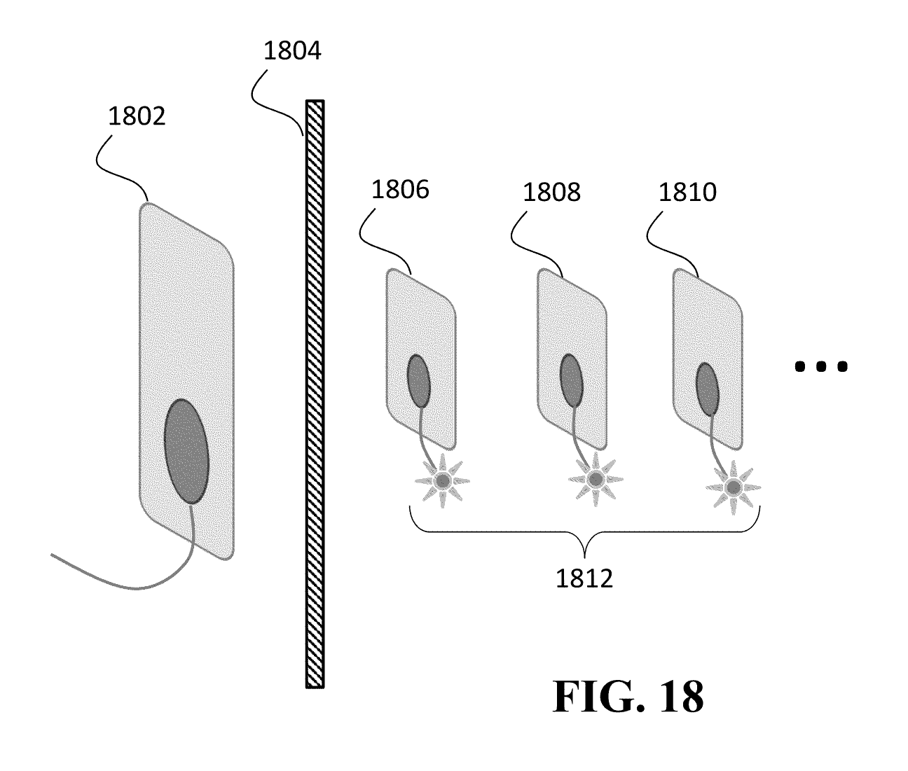

In embodiments, a wireless energy transfer system may comprise printed resonator coils that may be integrated into packaging for products on store stands or shelves. FIG. 18 shows an embodiment of a system in which a wireless power source 1802 may be positioned behind a wall or barrier 1804 to wirelessly transmit energy to devices 1806, 1808, 1810. For example, these devices may have an LED 1812 to catch the attention of a customer walking by the store shelf. In some embodiments, some of the devices may be repeaters. For example, for source 1802 to efficiently transfer power to a device that is further than others, such as device 1810, devices 1806 and 1808 may act as repeaters.

In some embodiments, a wireless energy transfer system may comprise a printed resonator coil that may be integrated into a paper material used in a card, poster, signage, presentation, advertisement, promotional material, magazine, newspaper, tickets, wallpaper, games, notebooks, etc. A card with a printed resonator may be a gift card, greeting card, business card, and the like. The resonator coil may be used energize a function such as playing a recording or music, displaying lights or a message, producing a smell, changing temperature or texture, etc. In other embodiments, the system may be used as entertainment or social interaction.

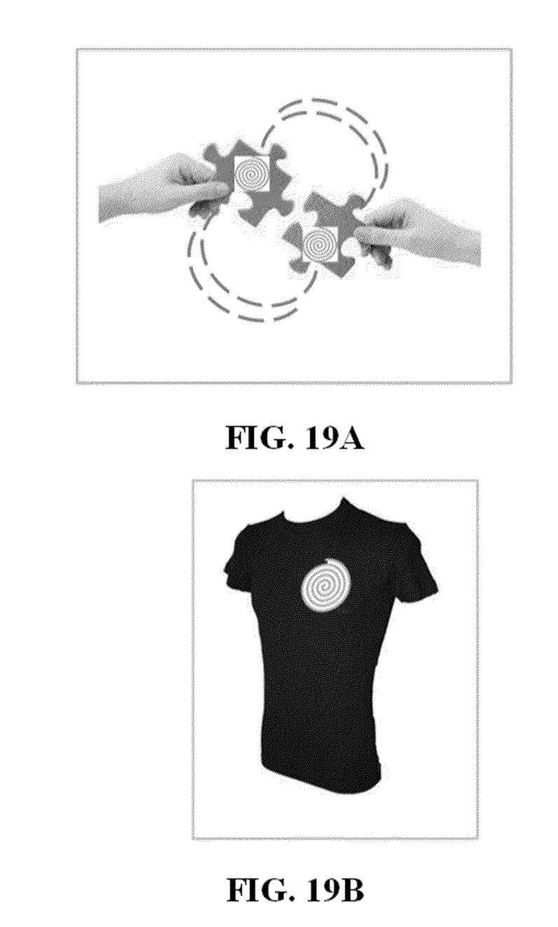

For example, such a system may be a game or puzzle that requires the user to bring a printed coil component near another coil so that the user's component may be energized. The energy may be used to produce a message or point to the next clue in the puzzle. The resonators in each puzzle piece may be repeater resonators as in FIG. 19A. Repeater resonators may be printed on each puzzle piece. When a complete puzzle is assembled energy may be coupled into one end of the puzzle and distributed through the puzzle by the repeater resonators to display an image, a message, or perform other functions.

In some embodiments, the system may comprise a printed resonator coil that may be integrated into fabric used in clothing, furniture, bedding, carpeting, and the like. In preferred embodiments, the resonator coil may be integrated into clothing material as in FIG. 19B. The resonators may be used to energize a function such as playing a recording or music, displaying lights or a message, producing a smell, changing temperature or texture, etc. In some embodiments, the material may be used as advertisement or entertainment.

In some embodiments, the system may comprise a printed resonator coil that may be integrated into plastics used in toys, gadgets, games, promotional material, etc.

In some embodiments, the system may comprise a printed resonator coil that may be integrated into eating utensils. The eating utensils may be made of various materials, such as paper or plastic and may include cups, bowls, plates, forks, spoons, knives, chopsticks, placemats, and the like. In preferred embodiments, the coil may be printed on a utensil to keep food or drink at a specific temperature or to increase or decrease the temperature of the food or drink.

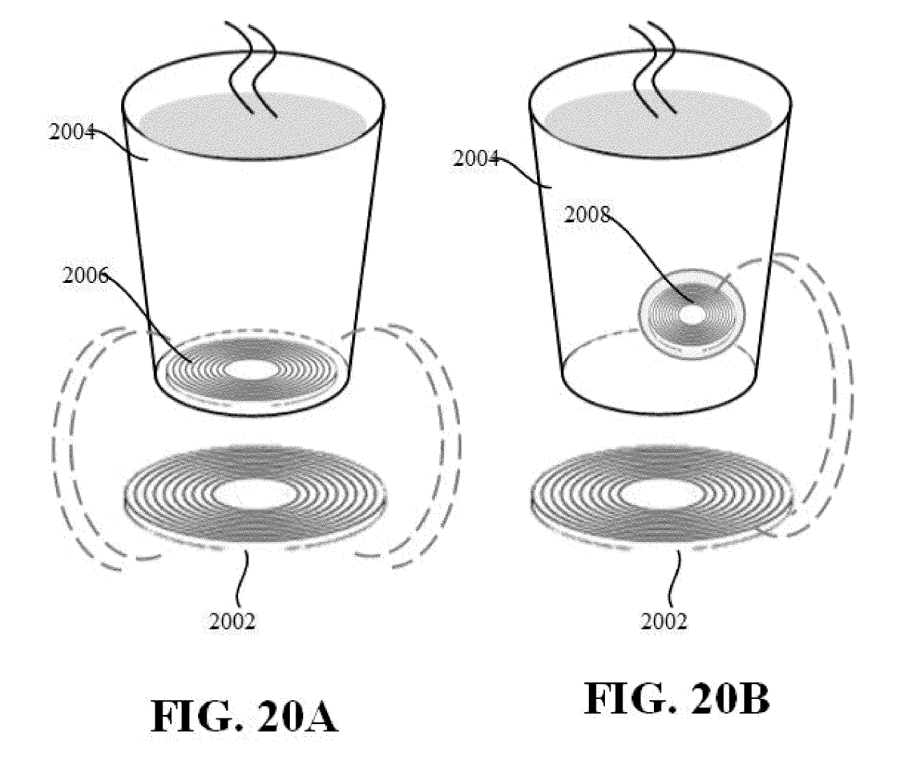

FIG. 20A shows an embodiment of a system comprising a beverage cup 2004 that has a printed coil 2006 on its bottom surface which may be energized by coupling with a source coil 2002 that may integrated into a table, cup holder, and other locations. The energy may be utilized to warm or cool the beverage in the cup 2004. Alternatively, the printed coil 2008 may be integrated into a plastic or other material that can be placed into a beverage as depicted in FIG. 20B. Similarly, the coil may couple with a source coil 2002 to warm or cool the beverage.

In embodiments, disposable products, such as beverage cups may include disposable resonators and resonator coils that may be configured to self-destruct after one or more uses or after a specific time period. In the example of the configuration shown in FIG. 20A, a printed resonator coil configured to heat the contents of a cup as shown in FIG. 20A, may be printed with conductive inks on the inside bottom of the cup. The printed coil and/or heating element may be covered or coated with a layer of porous material that may, temporarily, isolate the printed coil from the contents of the cup. The layer of porous material may be configured to slowly over, say, 2 minutes or more, allow any liquid to penetrate the layer and disable the printed resonator coil.

In some embodiments, the conductive ink may be configured to change parameters in response to changes in temperature. In one example, the resistance of the conductive ink may quickly change with changes in temperature. The resistance of the ink may, in some embodiments, increase as the temperature increases. In some embodiments, the resistance may decrease with increased temperature. When energy is transferred to a resonator comprising a printed coil and the temperature of the coil increases the resistance of the resonator may increase decreasing the quality factor of the resonator which may reduce or practically eliminate energy transferred to the resonator. In some cases, a 10 C degree change in temperature may change the resistance of a printed coil. In embodiments the resistance may change by 2 or 20 or even 200 ohms.

In some embodiments, the system may comprise a resonator coil that may be integrated into a flammable material. The flammable material may include paper, wood, plastics, etc. In preferred embodiments, the coil may be printed on products intended to start a controlled fire. For example, the coil may be printed on paper or wood that may be used in fireplaces, camp fires, fire pits or bowls, candles. In some embodiments, the coil may be driven with a pulse of energy that creates a spark without overheating the coil and affecting its performance.

### Medical Monitor

Wireless energy transfer may be used to power medical equipment such as medical monitors. Medical monitors may be used for monitoring patients or displaying medical information. In hospital or clinical settings, medical monitors may be placed on a stand with wheels to enable ease of movement from one location to another. Traditionally, wires may be used to transmit power to the electronic displays, monitors, computers on the mobile stands. However, wires may inhibit the ability to move the monitors freely, such as within a hospital setting.

In embodiments, a wirelessly powered medical monitor may comprise one or more resonators and electronics. The wireless energy source may comprise one or more resonators and electronics. The wireless energy source may be coupled to a power supply such as AC mains, a battery, a solar panel, a generator, and the like. FIG. 14 shows an exemplary wireless energy system for a medical monitor. In some embodiments, a wireless power source may be integrated into the floors, walls, or ceiling of a building, such as a hospital or clinic. In some embodiments, a medical monitor may be moved to a location where it may efficiently charge, such as designated “wireless power” zones. In embodiments, a medical monitor may comprise a wirelessly chargeable battery. A wirelessly chargeable battery may be self-contained with no wired connections between the battery and the source of power. The power received from the wireless energy source may be used to charge a battery encased in the monitor or on the stand. In some embodiments, one or more repeater resonators may be integrated into the stand of the medical monitor. This may increase the efficiency with which energy is transferred from a source to the medical monitor.

While the invention has been described in connection with certain preferred embodiments, other embodiments will be understood by one of ordinary skill in the art and are intended to fall within the scope of this disclosure, which is to be interpreted in the broadest sense allowable by law. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A wireless power station, comprising:
a base comprising at least one source resonator;
an interactive display terminal;
at least one sensor; and
a controller connected to the at least one source resonator, the display terminal, and the sensor,
wherein during operation of the system, the controller is configured to:
determine a location of a user of the wireless power station based on measurement information from the sensor;
activate the at least one source resonator to generate a magnetic field to wirelessly transmit electrical power to a receiver resonator positioned in footwear worn by the user;
display a request for user input on the interactive display terminal; and
discontinue wireless power transfer if a response to the request is not received from the user after a time interval.

2. The wireless power station of claim 1, wherein the controller is configured to activate the at least one source resonator near the location of a user.

3. The wireless power station of claim 1, wherein the interactive display terminal displays interactive marketing content.

4. The wireless power station of claim 1, wherein the at least one sensor comprises a pressure sensor.

5. The wireless power station of claim 1, wherein the base is configured to transfer energy to footwear positioned on a top surface of the base, and the at least one source resonator is arranged with its dipole moment perpendicular to the top surface of the base.

6. The wireless power station of claim 1, wherein the warming station is in a ski lift line.

7. A footwear insole, comprising:
a core formed of a non-metallic material and comprising an upper surface and a lower surface, wherein the upper surface is positioned closer to a user's foot than the lower surface when the insole is worn;
a heating element attached to the upper surface; and
a resonator comprising a resonator coil attached to the lower surface and positioned so that the resonator coil is laterally offset relative to the heating element,
wherein the resonator coil is oriented so that during operation of the insole, the resonator coil has a dipole moment perpendicular to a portion of the lower surface to which the resonator coil is attached.

8. The footwear insole of claim 7, wherein the heating element is a resistive heating element.

9. The footwear insole of claim 7, wherein the resonator coil comprises an electrically conductive thread.

10. The footwear insole of claim 7, further comprising a temperature sensor and a controller, wherein the controller is configured to change a resonant frequency of the resonator in response to temperature readings from the temperature sensor.

11. The footwear insole of claim 10, wherein the resonator is detuned from a set resonant frequency when the temperature reaches a threshold temperature.

12. The footwear insole of claim 7, further comprising a heat sensitive element that is configured to detune the resonator from a set resonant frequency as a temperature of the heating element increases.

13. The footwear insole of claim 12, wherein the heat sensitive element comprises a capacitive element coupled to the resonator coil, and wherein a capacitance of the heat sensitive element increases with increased temperature.

14. The footwear insole of claim 12, wherein the heat sensitive element comprises a capacitive element coupled to the resonator coil, and wherein a capacitance of the heat sensitive element decreases with increased temperature.

15. The footwear insole of claim 7, further comprising a wirelessly rechargeable battery.

16. A method for wirelessly transferring power to an article of footwear, the method comprising:
detecting a position of the footwear article relative to a wireless power source;
activating a wireless power source based on the detected position to wirelessly transfer power to the footwear article;
displaying a request for action to a wearer of the footwear article; and
discontinuing wireless power transfer to the footwear article if a response to the request is not received after a time interval.

17. The method of claim 16, further comprising detecting the position of the article relative to the source with proximity sensors.

18. The method of claim 16, further comprising detecting the position of the article relative to the source using the wireless power source.

19. The method of claim 16, wherein the request for action displayed to the wearer comprises interactive marketing material.

20. The method of claim 16, wherein the request for action displayed to the wearer comprises a temperature control.
